(19) United States
(12) Patent Application Publication
(10) Pub. No.: US 2026/0259684 A1
(43) Pub. Date: Sep. 3, 2026

(54) DATA WRITING METHOD AND MEMORY CONTROLLER

(71) Applicant: Hefei Kaimeng Technology Co., Ltd., Anhui (CN)

(72) Inventors: Jian HU, Anhui (CN); Wan Jun HONG, Anhui (CN); Tsung-Lin Wu, Anhui (CN); Qiao ZHU, Anhui (CN); Chong PENG, Anhui (CN)

(73) Assignee: Hefei Kaimeng Technology Co., Ltd., Anhui (CN)

(21) Appl. No.: 19/655,676

(22) Filed: Apr. 22, 2026

(30) Foreign Application Priority Data
Apr. 24, 2025 (CN) 202510524639.8

(51) Int. Cl. G06F 3/06

(52) U.S. Cl. CPC G06F 3/0659; G06F 3/0613; G06F 3/0679

(57) ABSTRACT

A data writing method and a memory controller are provided. In response to one or more Force Unit Access (FUA) write commands, a unique command identifier is assigned to each FUA write command, and phases experienced by the corresponding write operation are recorded. Write data corresponding to one or more command identifiers are consolidated and buffered into cache units corresponding to a plurality of planes. After a cache unit is full, the buffered data is written to a memory module via a multi-plane write mechanism. After all target write data corresponding to a target command identifier are successfully written, a success response is transmitted to a host system, indicating completion of the corresponding FUA write command. By using data structures to record the transfer state of each command, FUA protocol requirements are satisfied while data is consolidated in the buffer, improving write efficiency, reducing write amplification, and extending memory lifespan.

### CROSS-REFERENCE TO RELATED APPLICATION

This application claims the priority benefit of China application serial no. 202510524639.8, filed on April 24, 2025. The entirety of the above-mentioned patent application is hereby incorporated by reference herein and made a part of this specification.

### BACKGROUND

### TECHNICAL FIELD

The present disclosure relates to the field of memory technology, and more particularly, to a data writing method for FUA write commands and a memory controller.

### DESCRIPTION OF RELATED ART

Force Unit Access (FUA) write is a special write operation defined in the UFS (Universal Flash Storage) protocol. In general, for an ordinary write operation, a success response can be returned to the host once data is written to the buffer. For an FUA write, however, the data must be stored in a physical medium (e.g., flash memory) without error feedback in order to return a success response to the host, rather than simply storing the data in the device's buffer and then returning a success response to the host.

Therefore, FUA write commands are typically processed in a single-command serial manner, so that each FUA write command can have a corresponding response returned to the host system after the data is written to the flash memory. However, the single-command serial approach is inefficient, as it cannot fully utilize the multi-plane write capability of flash memory, and when the data of a certain FUA write command is small, dummy data must be padded, resulting in write amplification.

On the other hand, if data from multiple FUA write commands is consolidated in the buffer and then written as a single data block using multi-plane write, it becomes impossible to determine the status of each individual FUA write command, making it unable to fulfill the FUA write requirements in the UFS protocol.

### SUMMARY

In view of the foregoing, the present disclosure provides a data writing method and a memory controller therefor, which record the transfer state of FUA write commands through a plurality of data structures, enabling the state of each command's data to be tracked even when consolidating data in the buffer, so as to satisfy FUA protocol requirements and improve write efficiency.

One or more embodiments of the present disclosure provide a data writing method applied to a storage device configured with a memory module and a buffer memory. The memory module comprises a plurality of chips, and each chip has a plurality of physical blocks grouped into a plurality of planes. The method comprises: in response to one or more Force Unit Access write commands, assigning a unique command identifier to each Force Unit Access write command; recording information of a plurality of phases experienced by a write operation corresponding to each command identifier; consolidating and buffering(caching) write data corresponding to one or more command identifiers into cache units, which correspond to the plurality of planes, in the buffer memory; after the cache unit is full, writing the buffered write data of the cache unit to the memory module through a multi-plane write mechanism; and after all target write data corresponding to a target command identifier are successfully written to the memory module, transmitting a success response to a host system, so as to indicate that the target Force Unit Access write command corresponding to the target command identifier has been completed.

In one or more embodiments of the present disclosure, the plurality of phases comprise a trigger phase, a cache phase, and a completion phase, wherein: after the target Force Unit Access write command corresponding to the target command identifier is received, a target write operation of the target command identifier enters the trigger phase;

after the target write data corresponding to the target command identifier is consolidated and buffered into a target cache unit corresponding to the plurality of planes, the target write operation enters the cache phase,

after all target write data corresponding to the target command identifier are successfully written from the target cache unit to the memory module through the multi-plane write mechanism, the target write operation enters the completion phase.

In one or more embodiments of the present disclosure, recording information of the plurality of phases experienced by the write operation corresponding to each command identifier comprises: establishing a status information table to record general status information of each command identifier; maintaining a trigger linked list to record the command identifier corresponding to each received Force Unit Access write command; maintaining a wait linked list to record one or more command identifiers corresponding to each cache unit; and maintaining a completion linked list to record the command identifier corresponding to each completed Force Unit Access write command.

In one or more embodiments of the present disclosure, consolidating and buffering write data corresponding to one or more command identifiers into the cache units, which correspond to the plurality of planes, in the buffer memory comprises: extracting one or more first command identifiers from the trigger linked list to consolidate and buffer corresponding first write data into a first cache unit, wherein the size of the first write data equals the size of the first cache unit, and the size of the cache unit corresponds to one Flash Super Page (FSP) of the memory module; removing the one or more first command identifiers from the trigger linked list; and updating the one or more first command identifiers to the wait linked list and the status information table.

In one or more embodiments of the present disclosure, the status information table comprises structure elements in a quantity corresponding to a maximum number of command identifiers, each structure element corresponding to one command identifier on a one-to-one basis, and each structure element comprises: a next pointer field for pointing to the next command identifier following the corresponding command identifier; a cache unit count field for recording the total number of cache units storing the write data corresponding to the command identifier; a completion flag field for indicating whether all write data corresponding to the command identifier has been buffered; and an error flag field for indicating whether the write data corresponding to the command identifier encountered an error during the write process.

In one or more embodiments of the present disclosure, the trigger linked list comprises: a first head pointer field for pointing to the first command identifier in the trigger linked list; a first tail pointer field for pointing to the last command identifier in the trigger linked list; and a first count field for recording the total number of command identifiers contained in the trigger linked list.

In one or more embodiments of the present disclosure, after the target Force Unit Access write command is received, the method further comprises: if the trigger linked list is empty, updating the corresponding target command identifier to the first head pointer field and the first tail pointer field of the trigger linked list, and setting the first count field of the trigger linked list to one; if the trigger linked list is not empty, updating the next pointer field of the structure element corresponding to the command identifier currently pointed to by the first tail pointer field in the status information table to the target command identifier, updating the target command identifier to the first tail pointer field of the trigger linked list, and incrementing the value of the first count field of the trigger linked list by one.

In one or more embodiments of the present disclosure, the total number of wait linked list elements in the wait linked list is configured according to the number of chips in the memory module, and each wait linked list element corresponds to one cache unit, wherein each wait linked list element comprises: a second head pointer field for pointing to the first command identifier associated with the corresponding cache unit; a second tail pointer field for pointing to the last command identifier associated with the corresponding cache unit; and a second count field for recording the total number of all command identifiers associated with the corresponding cache unit, wherein when the target write data corresponding to the target command identifier is buffered to the target cache unit, the target command identifier is updated to the target wait linked list element associated with the target cache unit, and the value of the cache unit count field of the corresponding structure element in the status information table is incremented by one.

In one or more embodiments of the present disclosure, after the buffered write data of the target cache unit is successfully written to the memory module, the method further comprises: decrementing by one the value of the cache unit count field of the structure element in the status information table associated with each command identifier in the target wait linked list corresponding to the target cache unit; and clearing the target wait linked list.

In one or more embodiments of the present disclosure, the completion linked list comprises: a third head pointer field for pointing to the first command identifier in the completion linked list; a third tail pointer field for pointing to the last command identifier in the completion linked list; and a third count field for recording the total number of command identifiers contained in the completion linked list, wherein when the value of the cache unit count field of a target structure element corresponding to the target command identifier in the status information table decrements to zero and the completion flag field of the target structure element is a first value, the target command identifier is updated to the completion linked list, wherein after a success response corresponding to the target command identifier is transmitted to the host system, the target command identifier is removed from the completion linked list, and the third head pointer field of the completion linked list is updated to the next command identifier of the target command identifier.

One or more embodiments of the present disclosure provide a memory controller for controlling a storage device configured with a memory module and a buffer memory, wherein the memory module comprises a plurality of chips, and each chip has a plurality of physical blocks grouped into a plurality of planes. The memory controller comprises: a memory interface control circuit electrically connected to the memory module; and a processor electrically connected to the memory interface control circuit, wherein the processor is further electrically connected to a connection interface circuit of the storage device so as to be electrically connected to a host system. The processor is configured to: in response to one or more Force Unit Access write commands, assign a unique command identifier to each Force Unit Access write command; record information of a plurality of phases experienced by a write operation corresponding to each command identifier; consolidate and buffer write data corresponding to one or more command identifiers into cache units, which correspond to the plurality of planes, in the buffer memory; after the cache unit is full, write the buffered write data of the cache unit to the memory module through a multi-plane write mechanism; and after all target write data corresponding to a target command identifier are successfully written to the memory module, transmit a success response to a host system, so as to indicate that the target Force Unit Access write command corresponding to the target command identifier has been completed.

Based on the above, the data writing method and memory controller provided by the present disclosure achieve precise tracking of each command by assigning a unique command identifier to each Force Unit Access write command and recording state information of the plurality of phases experienced thereby. Write efficiency is improved by consolidating and buffering data from a plurality of commands into specific cache units that adopt a multi-plane write mechanism. At the same time, the method records the transfer state of each command in detail through a plurality of data structures, ensuring that a success response is transmitted to the host only after all data of the command has been successfully written to the memory module, fully satisfying the FUA write protocol requirements. This design not only satisfies the FUA write protocol requirements, but also resolves the problem of low efficiency in single-command serial processing and avoids the drawback of difficulty in tracking the state of individual commands in multi-command parallel processing, reduces write amplification, and effectively extends the service life of the memory module.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a host system and a storage device according to an embodiment of the present disclosure;

FIG. 2 is a flowchart of a data writing method according to an embodiment of the present disclosure;

FIG. 3 is a schematic diagram of a data transmission architecture according to an embodiment of the present disclosure;

FIG. 4 is a schematic diagram of recording information of a plurality of phases experienced by write operations corresponding to command identifiers according to an embodiment of the present disclosure;

FIG. 5 and FIG. 6 are sequence diagrams of a data writing method corresponding to Force Unit Access write commands according to an embodiment of the present disclosure;

FIG. 7 is a detailed schematic diagram of a status information table and a plurality of linked lists according to an embodiment of the present disclosure;

FIG. 8A to FIG. 8L are a series of schematic diagrams illustrating state changes of various data structures during a plurality of phases of write operations of a plurality of Force Unit Access write commands according to an embodiment of the present disclosure.

### DESCRIPTION OF THE EMBODIMENTS

Reference will now be made in detail to exemplary embodiments of the present disclosure, examples of which are illustrated in the accompanying drawings. Wherever possible, the same reference numerals are used in the drawings and descriptions to refer to the same or similar parts.

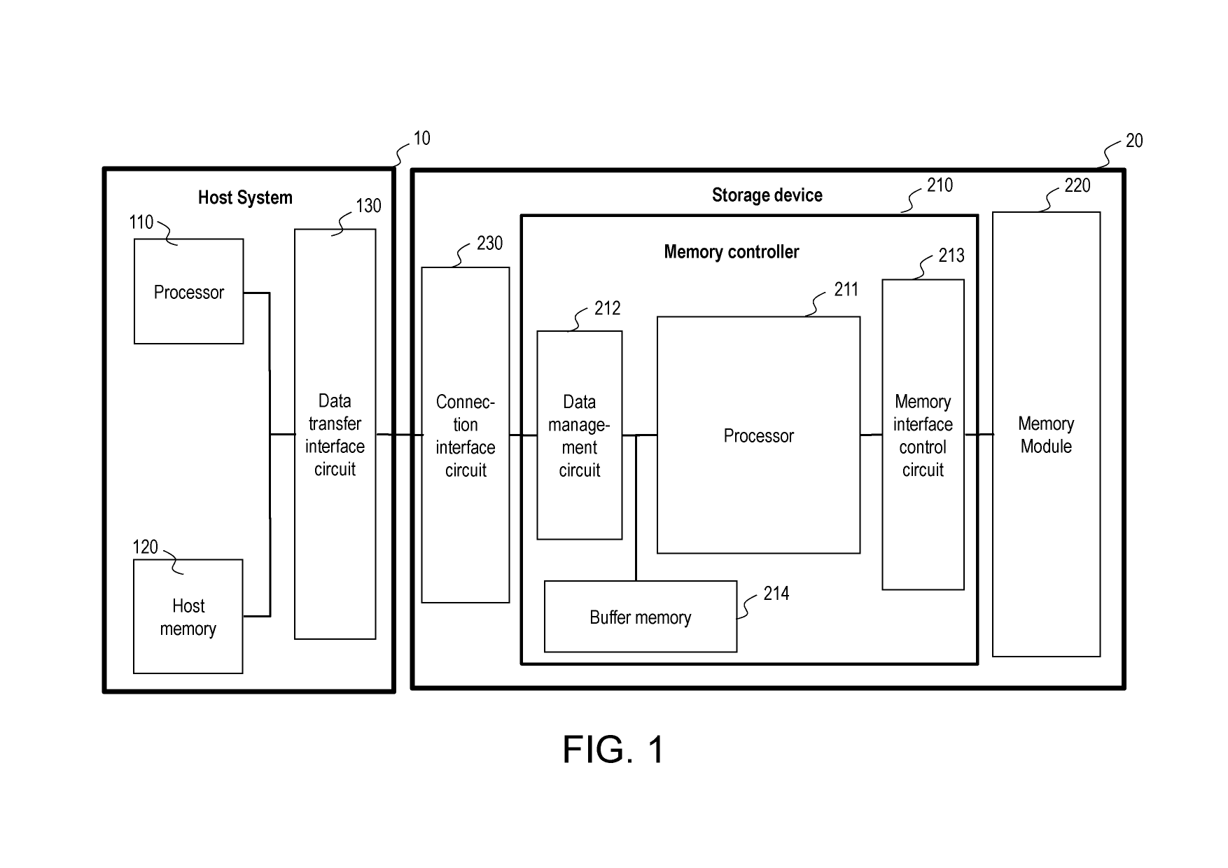

FIG. 1 is a block diagram of a host system and a storage device according to an embodiment of the present disclosure. Referring to FIG. 1, the host system 10 is, for example, a personal computer, a notebook computer, or a server. The host system (Host System) 10 comprises a processor (Processor) 110 (also referred to as the second processor), a host memory (Host Memory) 120, and a data transfer interface circuit (Data Transfer Interface Circuit) 130. In the present embodiment, the processor 110 is coupled to (also referred to as electrically connected to) the host memory 120 and the data transfer interface circuit 130. In another embodiment, the processor (Processor) 110, the host memory 120, and the data transfer interface circuit 130 are electrically connected to each other via a system bus (System Bus). In the present embodiment, the processor 110, the host memory 120, and the data transfer interface circuit 130 may be disposed on a motherboard of the host system 10.

The storage device 20 comprises a memory controller (Memory Controller) 210, a memory module (Memory Module) 220 (also referred to as a rewritable non-volatile memory module (Rewritable Non-Volatile Memory Module)), and a connection interface circuit (Connection Interface Circuit) 230. The memory controller 210 comprises a processor 211 (also referred to as the first processor), a data management circuit (Data Management Circuit) 212, a memory interface control circuit (Memory Interface Control Circuit) 213, and a buffer memory 214.

In the present embodiment, the host system 10 is electrically connected to the storage device 20 through the data transfer interface circuit 130 and the connection interface circuit 230 of the storage device 20 to perform data access operations. For example, the host system 10 may store data to the storage device 20 or read data from the storage device 20 via the data transfer interface circuit 130.

In the present embodiment, the number of data transfer interface circuits 130 may be one or more. Through the data transfer interface circuit 130, the motherboard may be electrically connected to the storage device 20 via a wired or wireless manner. The storage device 20 may be, for example, a USB flash drive, a memory card, a Solid State Drive (SSD), or a wireless memory storage device. The wireless memory storage device may be, for example, a Near Field Communication (NFC) memory storage device, a WiFi memory storage device, a Bluetooth memory storage device, or a low-power Bluetooth memory storage device (e.g., iBeacon), or other memory storage devices based on various wireless communication technologies. In addition, the motherboard may also be electrically connected via the system bus to various I/O devices such as a Global Positioning System (GPS) module, a network interface card, a wireless transmission device, a keyboard, a display, and speakers.

In the present embodiment, the data transfer interface circuit 130 and the connection interface circuit 230 are interface circuits compatible with the Peripheral Component Interconnect Express (PCI Express) standard. Moreover, data transmission between the data transfer interface circuit 130 and the connection interface circuit 230 is performed using the Non-Volatile Memory express (NVMe) communication protocol.

In addition, in another embodiment, the connection interface circuit 230 may be packaged together with the memory controller 210 in one chip, or the connection interface circuit 230 may be disposed outside a chip that includes the memory controller 210.

In the present embodiment, the host memory 120 is configured to temporarily store instructions or data executed by the processor 110. For example, in the present embodiment, the host memory 120 may be a Dynamic Random Access Memory (DRAM), a Static Random Access Memory (SRAM), or the like. However, it should be understood that the present disclosure is not limited thereto, and the host memory 120 may also be other suitable memories.

The memory controller 210 is configured to execute a plurality of logic gates or control instructions implemented in hardware form or firmware form, and to perform operations such as writing, reading, and erasing data in the memory module 220 according to instructions from the host system 10.

More specifically, the processor 211 in the memory controller 210 is hardware with computing capability, configured to control the overall operation of the memory controller 210. Specifically, the processor 211 is programmed by a plurality of control instructions/program codes, and when the storage device 20 is in operation, the control instructions/program codes are executed to perform operations such as writing, reading, and erasing data. In addition, in the present embodiment, the control instructions/program codes may further be executed to perform specific information management operations, so as to implement the data writing method optimized for Force Unit Access (FUA) write commands provided by the present disclosure. The control instructions/program codes corresponding to the data writing method may further be implemented as circuit units in hardware form, so as to implement the data writing method provided by the present disclosure.

It is worth noting that, in the present embodiment, the processor 110 and the processor 211 are, for example, a Central Processing Unit (CPU), a microprocessor (micro-processor), or other programmable processing units (Microprocessor), a Digital Signal Processor (DSP), a programmable controller, an Application Specific Integrated Circuit (ASIC), a Programmable Logic Device (PLD), or other similar circuit components, and the present disclosure is not limited thereto.

In the present embodiment, as described above, the memory controller 210 further comprises the data management circuit 212 and the memory interface control circuit 213. It should be noted that operations performed by the various components of the memory controller 210 may also be regarded as operations performed by the memory controller 210.

The data management circuit 212 is electrically connected to the processor 211, the memory interface control circuit 213, and the connection interface circuit 230. The data management circuit 212 is configured to receive instructions from the processor 211 to perform data transmission. For example, data is read from the host system 10 (e.g., the host memory 120) via the connection interface circuit 230, and the read data is written to the memory module 220 via the memory interface control circuit 213 (e.g., performing corresponding write operations according to various write instructions from the host system 10). As another example, data is read from one or more physical units of the memory module 220 via the memory interface control circuit 213 (data may be read from one or more storage cells in the one or more physical units), and the read data is written to the host system 10 (e.g., the host memory 120) via the connection interface circuit 230 (e.g., performing a read operation according to a read instruction from the host system 10). In another embodiment, the data management circuit 212 may also be integrated into the processor 211.

The memory interface control circuit 213 is configured to receive instructions from the processor 211, and cooperate with the data management circuit 212 to perform write (also referred to as programming, Programming) operations, read operations, or erase operations on the memory module 220.

In addition, data to be written to the memory module 220 is converted into a format acceptable to the memory module 220 via the memory interface control circuit 213. Specifically, when the processor 211 is to access the memory module 220, the processor 211 transmits corresponding instruction sequences to the memory interface control circuit 213 to instruct the memory interface control circuit 213 to execute corresponding operations. For example, the instruction sequences may include a write instruction sequence for indicating write data, a read instruction sequence for indicating read data, an erase instruction sequence for indicating erase data, and corresponding instruction sequences for indicating various memory operations. The instruction sequences may include one or more signals, or data on a bus. The signals or data may include instruction codes or program codes. For example, a read instruction sequence may include information such as a read identifier, a memory address, and a physical address.

Furthermore, the memory controller 210 establishes a logical-to-physical address mapping table (Logical To Physical address mapping table) and a physical-to-logical address mapping table (Physical To Logical address mapping table), so as to record the mapping relationship between the logical addresses of the logical units (e.g., logical blocks, logical pages) allocated to the memory module 220 and the physical addresses of the physical units (e.g., physical erase units/physical blocks, physical pages). In other words, the memory controller 210 may look up the physical unit mapped to a logical unit through the logical-to-physical address mapping table (also referred to as the logical-to-physical mapping table) (e.g., look up the physical page mapped to a logical page; look up the physical address mapped to a logical address), and the memory controller 210 may look up the logical unit mapped to a physical unit through the physical-to-logical address mapping table (also referred to as the physical-to-logical mapping table) (e.g., look up the logical page mapped to a physical page; look up the logical address mapped to a physical address).

The buffer memory 214 is electrically connected to the processor 211, and is configured to temporarily store data and instructions from the host system 10, data from the memory module 220, and various types of system data for managing the storage device 20. The buffer memory 214 may be configured with a write cache area dedicated to temporarily storing write data to be written to the memory module 220 through the multi-plane write mechanism. In an embodiment, the write cache area may correspond to one Flash Super Page (FSP), the size of which equals the sum of the sizes of one physical page from each of all planes of one chip in the memory module 220. For example, if each chip comprises M planes and the physical page size of each plane is P, then the size of the FSP is M × P. In an embodiment, each chip has 4 planes and each physical page has a size of 16 KB, so the total size of the FSP is 64 KB. The buffer memory 214 is further configured to store: (1) various address mapping tables (e.g., the logical-to-physical address mapping table and the physical-to-logical address mapping table), enabling the processor 211 to quickly access relevant data, instructions, or system data from the buffer memory 214; and (2) various data structures related to the data writing method of the present disclosure (e.g., status information table, trigger linked list, wait linked list, completion linked list, write data registers, etc.), which are used to record the flow states of the Force Unit Access (FUA) write commands and to enable tracking of the write data corresponding to each command identifier.

The memory module 220 is electrically connected to the memory controller 210 (the memory interface control circuit 213) and is configured to store user data transmitted by the host system 10. The memory module 220 supports the multi-plane write mechanism through its multi-plane structure, which is the key to improving the write efficiency of Force Unit Access (FUA) write commands. Specifically, each chip of the memory module 220 has a plurality of planes, each plane has a plurality of physical blocks, and each physical block comprises a plurality of physical pages. After the cache unit in the buffer memory 214 (e.g., a specific storage unit corresponding to the size of a Flash Super Page (FSP), referred to as a Flash Super Page Unit (FSPU)) is full, the memory controller 210 is able to utilize the multi-plane structure of the memory module 220 to simultaneously write data to a plurality of different planes in parallel, so as to improve write throughput. This structure enables the data writing method of the present disclosure to consolidate the data of a plurality of Force Unit Access (FUA) write commands in the cache and then efficiently write the data to the memory module 220 through a single multi-plane write operation, without having to perform a separate write operation for each command, so as to reduce write amplification and extend the service life of the memory module 220.

In the present embodiment, each physical page has a plurality of storage cells (also referred to as physical bytes or bytes), and each storage cell corresponds to one physical address. The physical address is used to record the physical location of data stored in the storage cell. It should be noted that the present disclosure is not limited to any particular size of each physical page and logical page.

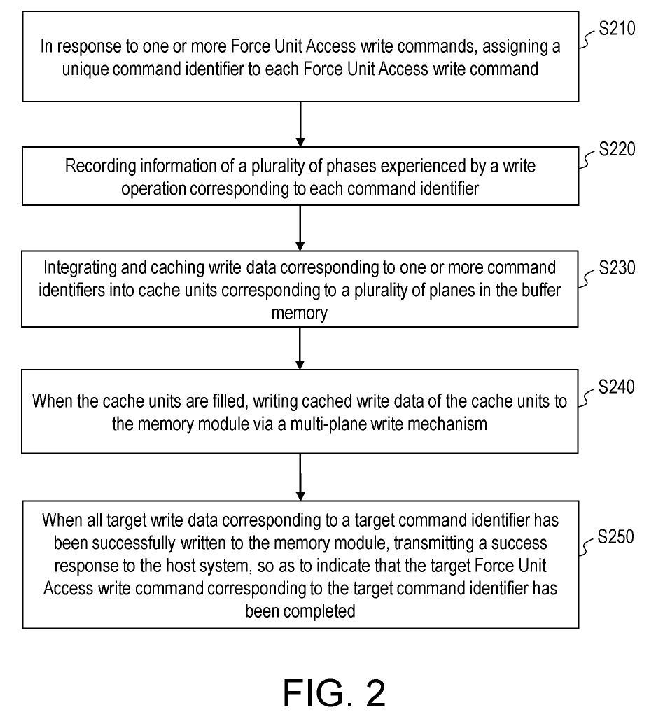

Referring to FIG. 2, a flowchart of the data writing method of the present disclosure is shown, the data writing method being applied to the storage device 20 configured with the memory module 220 and the buffer memory 214 as shown in FIG. 1. As described above, the memory module 220 comprises a plurality of chips, and each chip has a plurality of physical blocks grouped into a plurality of planes. The memory controller 210 may execute program codes or instructions stored in the buffer memory 214, so as to implement the data writing method shown in FIG. 2.

In step S210, the memory controller 210 (e.g., the processor 211), in response to one or more Force Unit Access (FUA) write commands, assigns a unique command identifier to each Force Unit Access (FUA) write command. Specifically, when the host system 10 transmits one or more Force Unit Access (FUA) write commands to the storage device 20 through the data transfer interface circuit 130, the memory controller 210 (in particular, the processor 211) receives the Force Unit Access (FUA) write commands and assigns a unique command identifier to each Force Unit Access (FUA) write command, so as to subsequently track the status/phase of the write operation of each Force Unit Access (FUA) write command. In the present embodiment, the command identifier may be a Command Tag (CTAG), the maximum number of which is MAX_CTAG_NUM, representing the upper limit of commands that the memory controller 210 can simultaneously process.

In step S220, the memory controller 210 records information on a plurality of phases experienced by a write operation corresponding to each command identifier. Specifically, in the present embodiment, the plurality of phases comprise a trigger phase, a cache phase, and a completion phase.

In an embodiment, after the memory controller 210 receives the target Force Unit Access (FUA) write command corresponding to the target command identifier, a target write operation of the target command identifier enters the trigger phase. Specifically, when the host system 10 transmits a target Force Unit Access (FUA) write command to the memory controller 210, the memory controller 210 assigns a unique target command identifier (CTAG) to the Force Unit Access (FUA) write command and adds the target command identifier to the trigger linked list (Trig_list), indicating that the command has been received and has entered the trigger phase.

In an embodiment, during the trigger phase, the memory controller 210 further initializes the structure element in the status information table corresponding to the target command identifier, setting its cache unit count field (Fsp_cnt) to zero, the completion flag field (Finish) to zero, and the error flag field (Err) to zero, in preparation for subsequent data processing and status tracking.

In an embodiment, after the target write data corresponding to the target command identifier is consolidated and cached into a target cache unit corresponding to the plurality of planes, the target write operation enters the cache phase. Specifically, the memory controller 210 extracts one or more command identifiers including the target command identifier from the trigger linked list, and consolidates and caches the corresponding write data into the selected target cache unit. At this point, the memory controller 210 removes the target command identifier from the trigger linked list, updates it to the corresponding wait linked list (Wait_list), and updates the value of the cache unit count field corresponding to the target command identifier in the status information table. When all target write data of the target command identifier has been cached, the memory controller 210 sets the corresponding completion flag field in the status information table to a first value (e.g., 1), indicating that the cache phase is complete.

In an embodiment, during the cache phase, depending on the size of the write data and the capacity of the cache unit, the memory controller 210 may need to distribute the data of one command across a plurality of cache units. Each time data is allocated to a new cache unit, the memory controller 210 increments the cache unit count field value of the corresponding command identifier by one, so as to record the number of cache units across which the command data is distributed.

In an embodiment, after all target write data corresponding to the target command identifier is successfully written from the target cache unit to the memory module 220 through the multi-plane write mechanism, the target write operation enters the completion phase. Specifically, when the target cache unit is full, the memory controller 210 writes the cached data in parallel to a plurality of planes of the memory module 220 through the multi-plane write mechanism. After the write operation is complete, the memory controller 210 decrements, by one, the value of the cache unit count field in the status information table associated with each command identifier in the wait linked list, indicating that the data of the cache unit has been successfully written.

The memory controller 210 monitors the operation status during the write process, and if an error occurs, sets the error flag field of the relevant command identifier to a first value (e.g., 1), so as to transmit an error response to the host system 10 during the completion phase, thereby allowing the host system 10 to return correct status information.

In another embodiment, the memory controller 210 may be configured to implement an error handling and recovery mechanism, so as to improve the robustness of the storage device 20 when executing Force Unit Access (FUA) write commands. In this embodiment, the memory controller 210 is not only capable of identifying write errors, but may also execute corresponding error recovery operations without immediately reporting the error status to the host system 10.

Specifically, when the memory controller 210 detects an error during the execution of a multi-plane write operation, the memory controller 210 first sets the error flag field of the relevant command identifier to a first value (e.g., 1), while simultaneously initiating an internal error recovery process, rather than reporting the error status to the host system 10. The memory controller 210 may be configured to perform one or more of the following error recovery operations: In the first error recovery operation, the memory controller 210 may attempt to reallocate the target write data to different physical locations in the memory module 220 for writing. Specifically, the memory controller 210 may re-execute the write operation from the cached data retained in the buffer memory 214, and further select other available physical blocks in the memory module 220 as the target locations. This operation allows the memory controller 210 to bypass physical areas that may experience temporary or permanent failures, so as to increase the probability of a successful write. In the second error recovery operation, the memory controller 210 may switch to a traditional Force Unit Access (FUA) write mode, i.e., a single-command serial processing mode. In this mode, the memory controller 210 removes the write data corresponding to the target command identifier from the wait linked list and the completion linked list, and re-processes the command according to the traditional Force Unit Access (FUA) write protocol, one command at a time, until all data of the command is successfully written to the memory module 220 or the preset maximum number of retry attempts is reached. The memory controller 210 may select an appropriate error recovery operation according to a preset strategy or based on the characteristics of the error. For example, for temporary errors, the memory controller 210 may prioritize the reallocation of physical locations; while for persistent errors or errors caused by hardware limitations, the memory controller 210 may choose to switch to the traditional mode write strategy. Only when all configured error recovery operations have failed, or when the preset maximum number of retry attempts has been reached, will the memory controller 210 report the error status to the host system 10. This multi-level error handling and recovery mechanism enables the storage device 20 to resolve most write errors internally, so as to reduce the frequency of reporting errors to the host system 10, thereby improving the overall system stability and user experience.

In an embodiment, the memory controller 210 is configured to execute a multi-phase command tracking and recording method for managing the processing status of Force Unit Access (FUA) write commands and their corresponding data. The method comprises maintaining a plurality of data structures to record information on a plurality of phases experienced by a write operation corresponding to each command identifier.

In a specific implementation, the memory controller 210 first establishes a status information table to record general status information of each command identifier. The status information table is implemented as an array of structure elements list_info[MAX_CTAG_NUM], wherein MAX_CTAG_NUM represents a maximum number of commands that the memory controller 210 can process simultaneously. For each command identifier, the status information table stores key status parameters, comprising: a next pointer field (next) pointing to a next command identifier in the linked list, a cache unit count field (fsp_cnt) recording the distribution of command data, a completion flag field (finish) indicating whether all data has been cached, and an error flag field (err) indicating whether an error occurs during the write process.

The memory controller 210 further maintains a trigger linked list (trig_list) dedicated to recording the command identifier corresponding to each received Force Unit Access (FUA) write command. When the host system 10 transmits a Force Unit Access (FUA) write command to the memory controller 210, the memory controller 210 assigns a unique command identifier (CTAG) to each command and adds it to the trigger linked list. The trigger linked list comprises a head pointer field (head), a tail pointer field (tail), and a count field (size), configured to indicate a first command identifier in the linked list, a last command identifier in the linked list, and a total number of command identifiers included in the linked list, respectively.

When the memory controller 210 is ready to cache data to the buffer memory 214, the memory controller 210 maintains a plurality of wait linked lists (wait_list) to record one or more command identifiers corresponding to each cache unit. Each wait linked list element corresponds to one cache unit, specifically, one FSPU. The number of wait linked list elements is typically configured as twice the number of chips in the memory module 220, so as to optimize resource utilization and ensure a continuous data processing flow. Each wait linked list element likewise comprises a head pointer field, a tail pointer field, and a count field, configured to manage a set of command identifiers associated with a specific cache unit.

When the memory controller 210 caches the data of a command identifier to a cache unit, the memory controller 210 removes the command identifier from the trigger linked list and adds it to the corresponding wait linked list. At the same time, the memory controller 210 updates the cache unit count field of the corresponding structure element in the status information table, incrementing its value to reflect the number of cache units in which the data of the command identifier is currently distributed.

The memory controller 210 further maintains a completion linked list (finish_list) dedicated to recording command identifiers corresponding to completed Force Unit Access (FUA) write commands. After the data of a cache unit is successfully written to the memory module 220, the memory controller 210 decrements the cache unit count field value of the associated command identifiers. When the cache unit count field value of a command identifier is decremented to zero and its completion flag field is a first value (indicating that all data has been previously cached), the memory controller 210 moves the command identifier from the wait linked list to the completion linked list, indicating that all data of the command has been successfully written to the memory module 220.

The completion linked list likewise comprises a head pointer field, a tail pointer field, and a size field, configured to manage command identifiers that have completed processing. The memory controller 210 traverses the completion linked list and transmits a corresponding success response or error response to the host system 10 based on the error flag field value of each command identifier. After transmitting the response, the memory controller 210 removes the command identifier from the completion linked list and clears the corresponding structure element in the status information table.

In an embodiment, after transmitting the response, the memory controller removes the processed command identifier from the completion linked list and releases the associated resources, in preparation for processing new write commands. This mechanism ensures that the status of each Force Unit Access (FUA) write command can be accurately tracked and reported even when data is being consolidated and processed in parallel.

Through this mechanism of multiple linked lists working in coordination, the memory controller 210 is capable of precisely tracking the processing status of each Force Unit Access (FUA) write command, achieving efficient parallel command processing, while satisfying the requirements of the Force Unit Access protocol for write confirmation.

In step S230, the memory controller 210 consolidates and caches write data corresponding to one or more command identifiers into cache units corresponding to the plurality of planes in the buffer memory 214. Specifically, the memory controller 210 extracts one or more first command identifiers from the trigger linked list to consolidate and cache corresponding first write data into a first cache unit, wherein a size of the first write data equals a size of the first cache unit, and the size of the cache unit corresponds to one Flash Super Page (FSP) of the memory module 220; removes the one or more first command identifiers from the trigger linked list; and updates the one or more first command identifiers to the wait linked list and the status information table.

In the present embodiment, each cache unit (e.g., an FSPU) corresponds to the sum of write units of all planes of one chip in the memory module 220. In this way, data of a plurality of command identifiers may be consolidated into the same cache unit, enabling subsequent write operations to fully utilize the multi-plane characteristics of the memory module 220.

In step S240, when the cache unit is full, the memory controller 210 writes the cached write data of the cache unit to the memory module 220 through a multi-plane write mechanism. Specifically, when a cache unit (e.g., an FSPU) is full, the memory controller 210 triggers a multi-plane write operation to simultaneously write data in parallel to a plurality of planes of a corresponding chip in the memory module 220. This parallel write mechanism improves write efficiency and reduces write time.

In step S250, after all target write data corresponding to the target command identifier are successfully written to the memory module 220, the memory controller 210 transmits a success response to the host system 10, so as to indicate that the target Force Unit Access (FUA) write command corresponding to the target command identifier has been completed. Specifically, after a write operation of an FSPU is completed, the memory controller 210 updates the cache unit count field, in the status information table, of all command identifiers associated with the FSPU. For command identifiers whose cache unit count field is decremented to zero and whose completion flag field is in a set state, the memory controller 210 adds them to the completion linked list. The memory controller 210 then extracts command identifiers from the completion linked list and transmits a corresponding success response or error response to the host system 10 based on the state of the error flag field.

Through the above steps, the data writing method of the present disclosure effectively addresses the problem of low efficiency of Force Unit Access (FUA) write commands. By assigning a unique identifier to each command and recording its status, the completion status of each command can be accurately tracked while data is being consolidated for writing. This method not only satisfies the requirements of the UFS protocol for FUA writes (i.e., data must be successfully written to a non-volatile storage medium before a success response can be returned), but also optimizes write performance through multi-command data consolidation and multi-plane parallel writing, reducing memory wear caused by write operations, thereby extending the service life of the memory module 220.

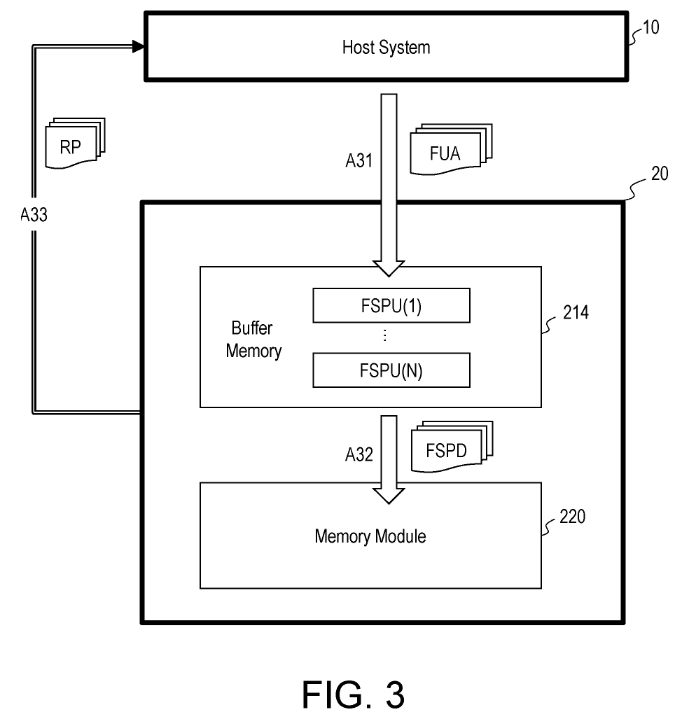

FIG. 3 illustrates a schematic diagram of a data transmission architecture according to an embodiment of the present disclosure.

Referring to FIG. 3, in an embodiment, the host system 10 transmits a Force Unit Access (FUA) write command to the storage device 20, and the storage device 20 is configured to process the Force Unit Access (FUA) write command and return a corresponding response RP to the host system 10.

The storage device 20 comprises the buffer memory 214 and the memory module 220. The buffer memory 214 is configured to temporarily store data from the host system 10, wherein the buffer memory 214 is partitioned into a plurality of cache units, and each cache unit corresponds to one Flash Super Page (FSP). As shown in FIG. 3, the buffer memory 214 comprises a plurality of cache units FSPU(1) through FSPU(N), wherein N is a positive integer representing a total number of cache units available in the buffer memory 214. In an embodiment, the total number of cache units may be set to twice the total number of chips of the memory module.

During data transfer, as indicated by arrow A31, the host system 10 transmits a Force Unit Access (FUA) write command to the storage device 20. After receiving the Force Unit Access (FUA) write command, the memory controller 210 within the storage device 20 assigns a unique command identifier to each Force Unit Access (FUA) write command. Subsequently, the memory controller 210 consolidates and caches write data corresponding to one or more command identifiers into cache units corresponding to a plurality of planes in the buffer memory 214, that is, storing the write data in one or more cache units FSPU(1) through FSPU(N).

After the cache unit corresponding to a Flash Super Page (e.g., FSPU(1)) is full, as indicated by arrow A32, the memory controller 210 writes the cached write data FSPD in the cache unit to the memory module 220 through the multi-plane write mechanism. Unlike a conventional single-command serial processing approach, the architecture of the present disclosure allows data of a plurality of Force Unit Access (FUA) write commands to be consolidated in the buffer memory 214 and then written to the memory module 220 in bulk, so as to improve write efficiency and reduce write amplification.

The memory controller 210 maintains a plurality of data structures (e.g., a status information table, a trigger linked list, a wait linked list, and a completion linked list), so as to accurately track the status of the write operation corresponding to each command identifier. According to the completion linked list, after all target write data corresponding to the target command identifier are successfully written to the memory module 220, as indicated by arrow A33, the memory controller 210 transmits a response RP to the host system 10, so as to indicate that the target Force Unit Access (FUA) write command corresponding to the target command identifier has been successfully completed.

Compared to conventional methods, the data transfer architecture of the present disclosure has the following advantages: first, by consolidating data of a plurality of Force Unit Access (FUA) write commands in the buffer memory 214 and then writing to the memory module 220 in bulk in units of Flash Super Pages, the advantages of multi-plane parallel writing are fully utilized, improving write efficiency; second, by using a plurality of data structures to record status information of each command identifier, it is ensured that even in the case of data consolidation, the execution status of each Force Unit Access (FUA) write command can still be accurately tracked, satisfying the protocol requirements for Force Unit Access writes; finally, by reducing write operations of individual small data blocks, write amplification is reduced, extending the service life of the memory module 220.

In the architecture of the present disclosure, when the data volume of a plurality of Force Unit Access (FUA) write commands is small, the data may be consolidated into the same Flash Super Page, avoiding the conventional practice of adding dummy data for each small data block, further reducing write amplification. Meanwhile, because a plurality of data structures are used to record information on each phase of each Force Unit Access (FUA) write command, the memory controller 210 is able to ensure that a success response RP is transmitted to the host system 10 only after all data corresponding to the command has been successfully written to the memory module 220, so as to strictly comply with the protocol requirements for Force Unit Access writes.

Through this optimized data transfer architecture, the present disclosure achieves a dual enhancement in processing efficiency and reliability of Force Unit Access (FUA) write commands, providing effective support for applications requiring high-performance and high-reliability storage solutions.

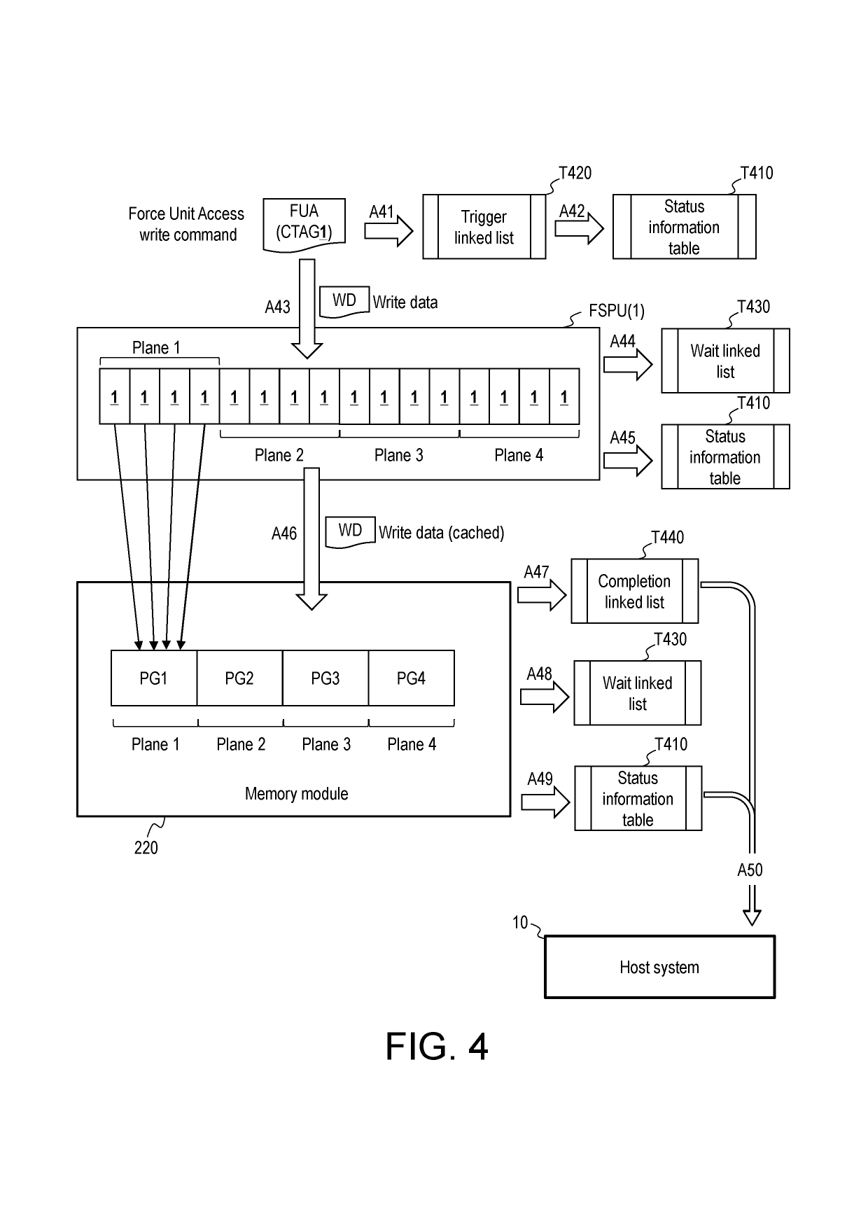

FIG. 4 is a schematic diagram illustrating, according to an embodiment of the present disclosure, information on a plurality of phases experienced by a write operation corresponding to a command identifier.

In an embodiment, referring to FIG. 4, after a Force Unit Access (FUA) write command (assumed to be assigned as CTAG1) is received, as indicated by arrow A41, the command identifier (e.g., CTAG1) of the command is first added to the trigger linked list T420. The trigger linked list T420 is used to record command identifiers of all Force Unit Access (FUA) write commands that have been received but not yet fully processed. Subsequently, as indicated by arrow A42, the memory controller 210 updates the status information table T410 to initialize corresponding status information for the newly received command identifier, including setting the next pointer field, the cache unit count field, the completion flag field, and the error flag field.

In an embodiment, the status information table T410 is implemented as a plurality of structure elements, each structure element having a one-to-one correspondence with one command identifier. After initialization is complete, the memory controller 210 begins processing the write data WD. As indicated by arrow A43, the write data WD is allocated to the cache unit FSPU(1) in the buffer memory 214. A plurality of cache sub-units of the cache unit FSPU(1) are partitioned into a plurality of plane regions (as shown in FIG. 4, one plane region comprises 4 cache sub-units), comprising Plane 1, Plane 2, Plane 3, and Plane 4, corresponding to a plurality of plane structures of chips in the memory module 220.

During the cache unit allocation process, as indicated by arrow A44, the memory controller 210 updates the wait linked list T430 to record the command identifier associated with the cache unit FSPU(1) (e.g., the write data WD corresponding to the command identifier has been cached to the cache unit FSPU(1)). Meanwhile, as indicated by arrow A45, the memory controller 210 updates the cache unit count field of the structure element of the corresponding command identifier in the status information table T410, incrementing the value by 1 to indicate that the write data corresponding to the command identifier has been allocated to 1 cache unit. When all write data corresponding to the command identifier has been allocated to cache units, the memory controller 210 sets the corresponding completion flag field in the status information table T410 to a first value (e.g., 1).

After the cache unit FSPU(1) is full, as indicated by arrow A46, the memory controller 210 writes the cached write data to a plurality of planes of the memory module 220 in parallel through the multi-plane write mechanism. As shown in FIG. 4, the cached write data WD in the cache unit FSPU(1) corresponding to Plane 1 through Plane 4, respectively, is written in parallel to the corresponding physical pages PG1, PG2, PG3, and PG4 in the memory module 220. This multi-plane parallel write mechanism improves write efficiency, particularly for Force Unit Access (FUA) write commands with small data volumes, avoiding the write amplification problem in conventional methods.

After the cached write data WD is written to the memory module 220, as indicated by arrow A47, the memory controller 210 determines whether to update the completion linked list T440, so as to add the command identifier of the completed write to the completion linked list T440. Meanwhile, as indicated by arrow A48, since the cached data of the cache unit FSPU(1) has been programmed, the memory controller 210 clears the corresponding wait linked list T430 and, as indicated by arrow A49, updates the cache unit count field of the structure element of the relevant command identifier (e.g., CTAG1) in the status information table T410, decrementing the value by one.

In an embodiment, when the cache unit count field value corresponding to a command identifier is decremented to zero and the completion flag field thereof is a first value (indicating that all write data has previously been cached), it indicates that all data of the command has been successfully written to the memory module 220 and the command processing is complete. At this point, the memory controller 210 moves the command identifier from the wait linked list T430 to the completion linked list T440, in preparation for transmitting a response to the host system 10.

Specifically, the memory controller 210 traverses the command identifiers in the completion linked list T440. For each completed command identifier, as indicated by arrow A50, the memory controller 210 queries the status information table T410 to determine whether an error occurred during the programming process of each completed command identifier (by looking up the error flag field), and accordingly transmits a response to the host system 10, so as to indicate that the corresponding Force Unit Access (FUA) write command has been successfully completed or has failed. After transmitting the response, the memory controller 210 removes the command identifier from the completion linked list T440 and clears the corresponding structure element in the status information table T410, releasing resources to process new FUA write commands subsequently received.

In the multi-plane write mechanism of the memory module 220, each chip typically comprises a plurality of planes (e.g., Plane 1 through Plane 4 as shown in FIG. 4). A cache unit may be regarded as a collection of data corresponding to physical pages of all planes in one chip. By distributing write data to different plane regions of a cache unit and then simultaneously triggering multi-plane write operations corresponding to all planes, parallel writing is achieved, thereby improving write performance.

In the embodiments of the present disclosure, the four data structures, namely the status information table T410, the trigger linked list T420, the wait linked list T430, and the completion linked list T440, cooperate with one another to implement tracking of the various phases of the Force Unit Access (FUA) write command status. The trigger linked list T420 records received FUA write commands, the wait linked list T430 records FUA write commands being cached, the completion linked list T440 records FUA write commands for which programming has been completed, and the status information table T410 records auxiliary status information of each FUA write command throughout the entire processing procedure.

Through this cooperative multi-linked-list mechanism, the memory controller 210 is able to accurately track the processing status of each Force Unit Access (FUA) write command, achieve efficient parallel command processing, and simultaneously satisfy the strict requirements of the Force Unit Access protocol for write confirmation.

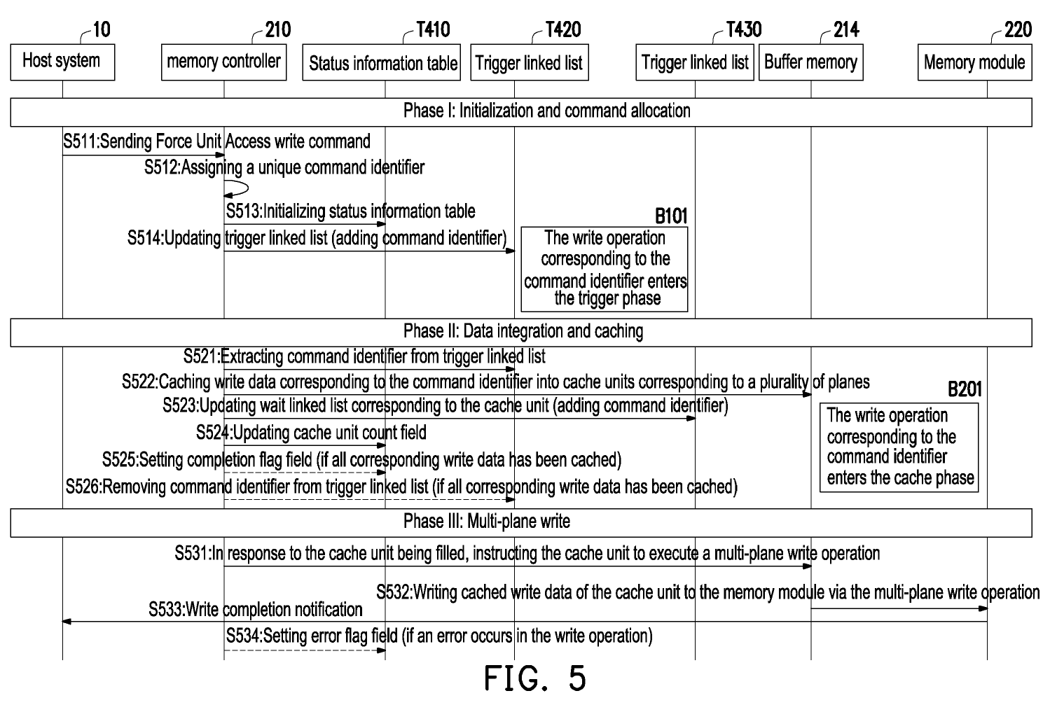

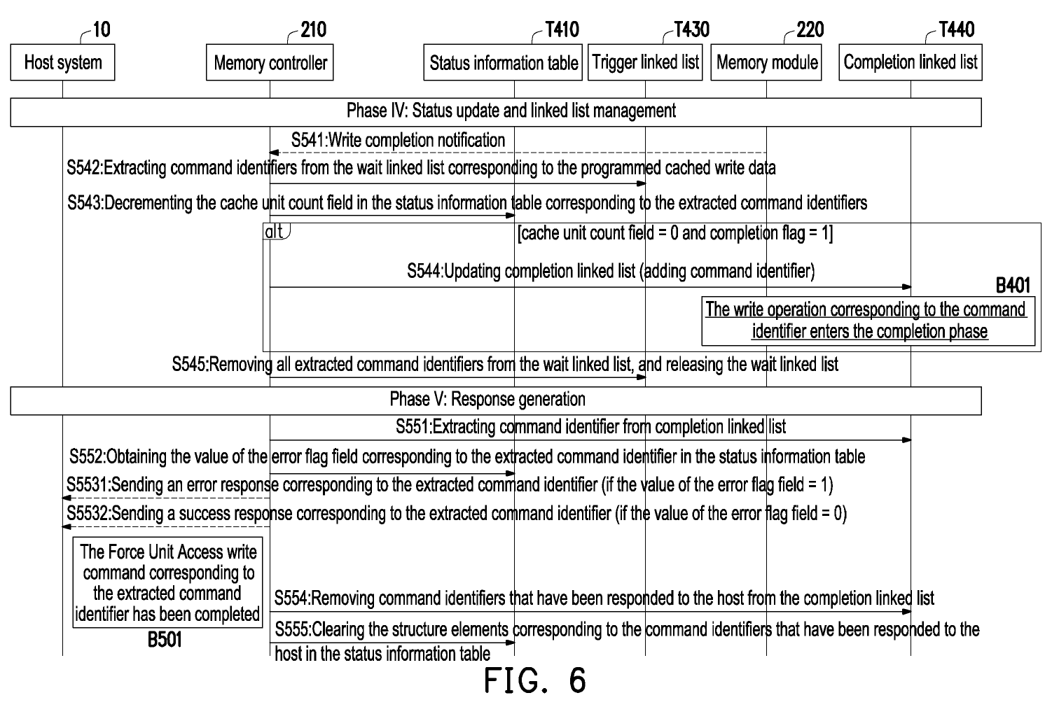

FIG. 5 and FIG. 6 are sequence diagrams of a data writing method corresponding to Force Unit Access (FUA) write commands, according to embodiments of the present disclosure.

In an embodiment, referring to FIG. 5, the sequence diagram describes in detail the interactions among the host system 10, the memory controller 210, the status information table T410, the trigger linked list T420, the wait linked list T430, the buffer memory 214, and the memory module 220, and illustrates the three main phases of the data writing method: Phase 1 (initialization and command assignment), Phase 2 (data consolidation and caching), and Phase 3 (multi-plane writing).

### Phase 1: Initialization and Command Assignment

In Phase 1, first, as shown in step S511, the host system 10 transmits a Force Unit Access (FUA) write command to the memory controller 210. After receiving the FUA write command, as shown in step S512, the memory controller 210 assigns a unique command identifier to the FUA write command. The assignment of the command identifier ensures that the memory controller 210 is able to uniquely identify and track each Force Unit Access (FUA) write command throughout the entire processing procedure.

Subsequently, as shown in step S513, the memory controller 210 initializes the status information table T410. Specifically, the memory controller 210 creates a structure element in the status information table T410 for the newly assigned command identifier, and initializes each of its fields: the next pointer field is set to a null value, the cache unit count field is set to zero, the completion flag field is set to zero (indicating that the data has not yet been fully cached), and the error flag field is set to zero (indicating that no error has occurred yet).

Next, as shown in step S514, the memory controller 210 updates the trigger linked list T420, adding the command identifier of the new FUA write command to the trigger linked list T420. If the trigger linked list T420 is empty, the command identifier is set as the head pointer and tail pointer of the trigger linked list T420, and the count field is set to one; if the trigger linked list T420 is not empty, the command identifier is added to the tail of the linked list, the tail pointer is updated, and the count field is incremented by one.

After these initialization and command assignment operations are completed, as indicated by B101, the write operation corresponding to the command identifier may be regarded as entering the trigger phase.

### Phase 2: Data Consolidation and Caching

In Phase 2, as shown in step S521, the memory controller 210 extracts command identifiers from the trigger linked list T420. When data needs to be processed, the memory controller 210 starts from the head of the trigger linked list T420 and sequentially retrieves command identifiers in order to process the corresponding write data.

As shown in step S522, the memory controller 210 consolidates and caches write data corresponding to the command identifiers into cache units corresponding to the plurality of planes. In this step, the memory controller 210 consolidates write data from a plurality of commands into cache units (e.g., Flash Super Pages) of the buffer memory 214, making full use of the multi-plane structure to improve write efficiency. This consolidation mechanism may avoid the write amplification problem caused by writing individual small data blocks.

Subsequently, as shown in step S523, the memory controller 210 updates the wait linked list T430 corresponding to the cache unit, adding the command identifier to the wait linked list T430 associated with the cache unit. Meanwhile, as shown in step S524, the memory controller 210 updates the count field of the wait linked list T430 element, recording the total number of command identifiers associated with the corresponding cache unit.

When all write data of one FUA write command has been cached, as shown in step S525, the memory controller 210 sets the completion flag field, setting the completion flag field of the corresponding command identifier in the status information table T410 to a first value, indicating that all data has been cached. In addition, as shown in step S526, the memory controller 210 removes the fully cached command identifier from the trigger linked list T420, completing the maintenance of the trigger linked list T420 by updating the fields.

After these operations are completed, as shown in B201, the write operation for the command identifier enters the cache phase, and the data has been consolidated and stored in the buffer memory 214, waiting to be written to the memory module 220.

### Phase Three: Multi-Plane Write

In phase three, as shown in step S531, when a cache unit is full, the memory controller 210 executes a write operation corresponding to the cache unit, instructing a multi-plane write operation to be performed on the cached write data of the cache unit. As shown in step S532, the memory controller 210 writes the data in the cache unit in the buffer memory 214 simultaneously to physical pages of a plurality of planes of the memory module 220 through the multi-plane write mechanism, achieving parallel writing and improving write performance. In addition, this also ensures that the write data of the FUA write command has been successfully transferred from the buffer memory 214 to the memory module 220, and prepares for subsequent status updates.

Next, after the multi-plane write operation is completed, as shown in step S533, the memory module 220 transmits a write completion notification to the memory controller 210. The notification indicates that the memory module 220 has completed the physical write operation of all specified data. Upon receiving the notification, the memory controller 210 checks whether an error occurred during the write process. Subsequently, based on the check result, as shown in step S534, if an error occurs during the write process, the memory controller 210 sets the error flag field of the corresponding command identifier to a first value (e.g., 1); otherwise, it remains at a zero value (indicating that no error occurred during the write process corresponding to the command identifier). This step ensures that even in the case of data consolidation and multi-plane writing, the execution status of each command can still be accurately tracked.

In an embodiment, referring to FIG. 6, the sequence diagram describes in detail the interaction process among the host system 10, the memory controller 210, the status information table T410, the wait linked list T430, the memory module 220, and the completion linked list T440 in phase four (status update and linked list management) and phase five (response generation).

### Phase Four: Status Update and Linked List Management

In phase four, the data write operation enters the critical status update and linked list management phase. First, as shown in step S541, the memory module 220 transmits a write completion notification to the memory controller 210. The notification indicates that the memory module 220 has successfully completed the physical write operation of the data, ensuring that the Force Unit Access (FUA) write command satisfies the protocol requirements.

After receiving the write completion notification, as shown in step S542, the memory controller 210 extracts the relevant command identifiers from the wait linked list T430 corresponding to the programmed cached write data. These command identifiers point to all FUA write commands involved in the currently completed write operation. Subsequently, as shown in step S543, the memory controller 210 decrements the cache unit count field of the corresponding extracted command identifiers in the status information table T410. The cache unit count field indicates how many cache units the command data is distributed across; each time the data of a cache unit is successfully written to the memory module 220, the value of the field is decremented by one.

When the cache unit count field is decremented to zero and the completion flag is a first value, it indicates that all cached write data of the FUA write command has been successfully written to the memory module 220. In this case, as shown in step S544, the memory controller 210 updates the completion linked list T440, adding the corresponding command identifier to the completion linked list T440. As shown in B401, the write operation corresponding to the command identifier enters the completion phase at this point, ready to transmit a response to the host system 10.

Finally, as shown in step S545, the memory controller 210 removes all extracted command identifiers from the wait linked list T430 and releases the resources of the emptied wait linked list T430, so as to subsequently process new FUA write commands (e.g., the write data of new FUA write commands is cached into the corresponding cache units). This resource management mechanism ensures that the storage device 20 can continuously process write commands transmitted by the host system 10, achieving high-throughput data processing.

### Phase Five: Response Generation

Phase five primarily handles the process of transmitting command completion responses to the host system 10. First, as shown in step S551, the memory controller 210 extracts command identifiers from the completion linked list T440. These command identifiers correspond to FUA write commands for which all data has been successfully written to the memory module 220, waiting to transmit operation completion responses to the host system 10.

Subsequently, as shown in step S552, the memory controller 210 obtains the value of the error flag field corresponding to the extracted command identifiers in the status information table T410. The field records whether an error occurred during the write process, providing a basis for the memory controller 210 to determine what type of response to transmit to the host system 10.

Based on the value of the error flag field, the memory controller 210 performs different response operations. As shown in step S5531, when the value of the error flag field is a first value (indicating that an error occurred), the memory controller 210 transmits an error response corresponding to the extracted command identifiers to the host system 10. Conversely, as shown in step S5532, when the value of the error flag field is zero (indicating that no error occurred), the memory controller 210 transmits a success response corresponding to the extracted command identifiers to the host system 10. As shown in B501, after the response is transmitted, the FUA write command corresponding to the extracted command identifier is completed.

After the completion response is transmitted, as shown in step S554, the memory controller 210 removes, from the completion linked list T440, the command identifier for which a response has been transmitted to the host system 10, maintaining the completion linked list T440. Finally, as shown in step S555, the memory controller 210 clears, from the status information table T410, the structure element corresponding to the command identifier for which a response has been transmitted to the host system 10, releasing the occupied resources in preparation for processing new FUA write commands.

Through the operations of phase four and phase five, the data writing method provided by the present disclosure achieves a complete processing cycle for Force Unit Access (FUA) write commands, ensuring secure data writing and providing accurate operation completion feedback to the host system 10.

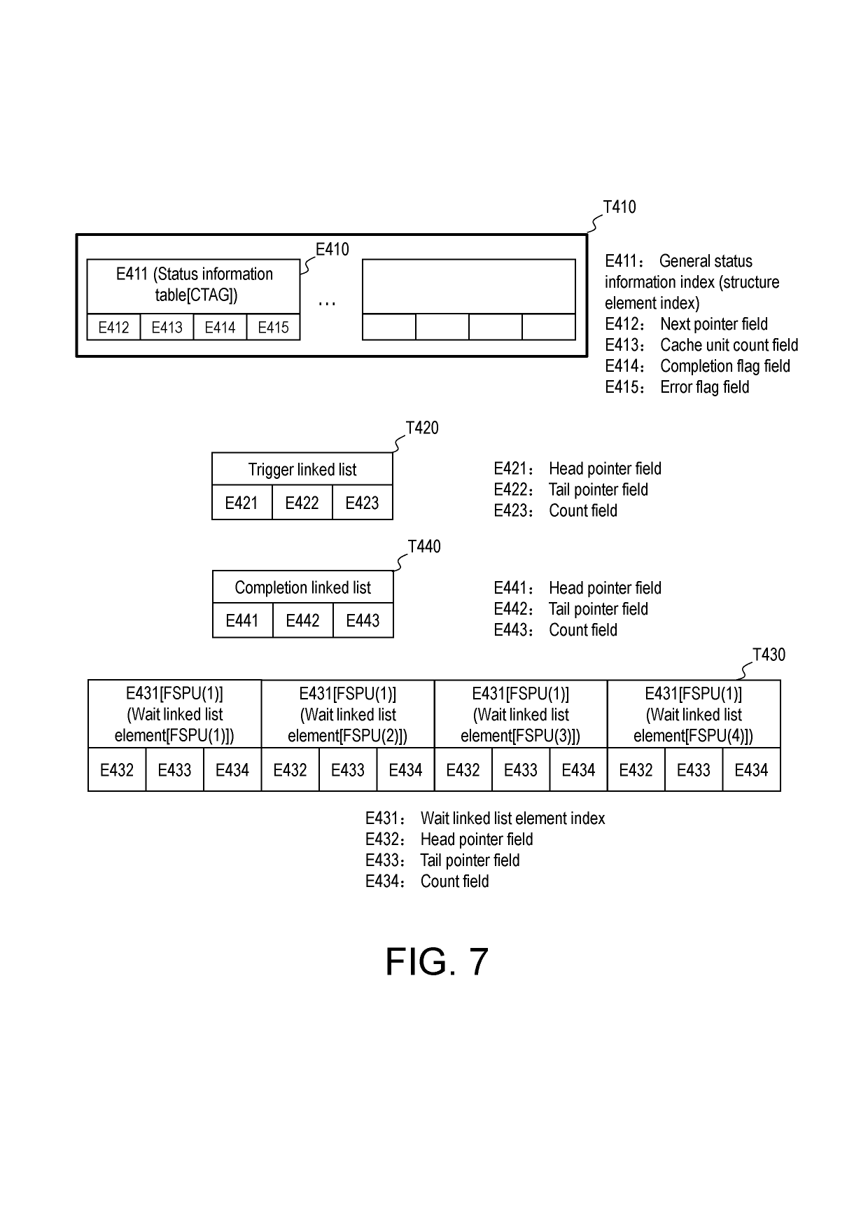

FIG. 7 is a detailed schematic diagram of the status information table and a plurality of linked lists according to an embodiment of the present disclosure.

In an embodiment, referring to FIG. 7, the present disclosure achieves precise tracking and management of Force Unit Access (FUA) write commands by designing a series of special data structures.

(1) Status Information Table

As shown in FIG. 7, the status information table T410 is implemented as an array of structures, comprising a plurality of structure elements E410, each structure element E410 having a one-to-one correspondence with one command identifier. The general status information index E411 (structure element index) represents the command identifier [CTAG] corresponding to the structure element. Each structure element E410 comprises the following four fields:

a next pointer field E412, configured to point to a next command identifier following the command identifier in the linked list;

a cache unit count field E413, configured to record a total number of cache units storing write data corresponding to the command identifier;

a completion flag field E414, configured to indicate whether all write data corresponding to the command identifier has been cached;

an error flag field E415, configured to indicate whether an error occurs during writing of the write data corresponding to the command identifier.

The size of the status information table T410 is typically set to a predetermined size MAX_CTAG_NUM, which is the maximum number of commands that the memory controller can process simultaneously. By maintaining such an array of structures, the memory controller is able to efficiently access and update the status information of each command identifier, providing necessary information support for each phase of command processing.

(2) Trigger Linked List

The trigger linked list T420 is used to record the command identifier corresponding to each received Force Unit Access (FUA) write command. As shown in FIG. 7, the trigger linked list T420 comprises three key fields:

a head pointer field E421 (also referred to as the first head pointer field), configured to point to a first command identifier in the trigger linked list T420;

a tail pointer field E422 (also referred to as the first tail pointer field), configured to point to a last command identifier in the trigger linked list T420;

a count field E423 (also referred to as the first count field), configured to record a total number of command identifiers included in the trigger linked list T420.

When a new Force Unit Access (FUA) write command is received, the memory controller adds the command identifier thereof to the tail of the trigger linked list T420, and updates the relevant pointer and count values (e.g., the count field). When the data of a Force Unit Access (FUA) write command is fully cached, the corresponding command identifier is removed from the trigger linked list T420 (removed from the head pointer field), and the next command identifier can be looked up from the next pointer field E412 of the corresponding structure element, so as to update the head pointer field. The trigger linked list T420 implements linking between command identifiers through the next pointer field E412 in the status information table T410, forming an efficient singly linked list structure.

In an embodiment, the present disclosure further provides a method for efficiently managing the trigger linked list T420. After the memory controller 210 receives the target Force Unit Access (FUA) write command, the memory controller 210 first assigns a unique target command identifier to the command, and then adds the target command identifier to the trigger linked list T420. The specific method for updating the trigger linked list T420 has two different processing flows depending on the current state of the trigger linked list T420.

When the trigger linked list T420 is empty, the memory controller 210 directly updates the target command identifier to the head pointer field E421 and the tail pointer field E422 of the trigger linked list T420, such that both the head pointer and the tail pointer point to the target command identifier, and simultaneously sets the count field E423 of the trigger linked list T420 to one, indicating that there is currently only one command identifier in the trigger linked list T420. At this point, the trigger linked list T420 contains only the newly added target command identifier, and there is no need to update the next pointer field E412 in the status information table T410.

When the trigger linked list T420 is not empty, the operation of adding a new command identifier is more complex and requires maintaining the integrity of the linked list. The memory controller 210 first obtains the current tail command identifier from the tail pointer field E422 of the trigger linked list T420, and then updates the next pointer field E412 of the structure element E410, in the status information table T410, corresponding to the tail command identifier to the target command identifier. Through this update, a link between the original tail command identifier and the new target command identifier is established. Subsequently, the memory controller 210 updates the target command identifier to the tail pointer field E422 of the trigger linked list T420, such that the tail pointer points to the newly added target command identifier. Finally, the memory controller 210 increments the value of the count field E423 of the trigger linked list T420 by one, reflecting the increase in the total number of command identifiers in the trigger linked list T420.

(3) Wait Linked List

The wait linked list T430 is used to record one or more command identifiers corresponding to each cache unit. As shown in FIG. 7, the wait linked list T430 comprises a plurality of wait linked list elements E431, each element corresponding to one cache unit (i.e., corresponding to one Flash Super Page), such as FSPU(1), FSPU(2), FSPU(3), and FSPU(4). According to a feature of the present disclosure, a total number of the plurality of wait linked list elements E431 of the wait linked list T430 is configured according to a number of chips in the memory module 220, so as to optimize resource utilization and ensure continuity of data processing.

Each wait linked list element E431 comprises three key fields:

a head pointer field E432 (also referred to as the second head pointer field), configured to point to a first command identifier associated with the corresponding cache unit;

a tail pointer field E433 (also referred to as the second tail pointer field), configured to point to a last command identifier associated with the corresponding cache unit;

a count field E434 (also referred to as the second count field), configured to record a total number of all command identifiers associated with the corresponding cache unit.

During data processing, when the memory controller 210 caches the target write data corresponding to the target command identifier to the target cache unit, the memory controller 210 performs two update operations: first, updating the target command identifier to the tail pointer field E433 of the target wait linked list element E431 associated with the target cache unit, establishing an association between the command identifier and the cache unit; second, incrementing the value of the cache unit count field E413 of the structure element E410, in the status information table T410, corresponding to the target command identifier by one, recording the number of cache units across which the data of the command is now distributed.

After the data in the cache unit is successfully written to the memory module 220, the corresponding command identifier is removed from the wait linked list element E431 (removed from the head pointer field E432), and the next command identifier is looked up through the next pointer field of the structure element of the removed command identifier, so as to update the head pointer field E432 of the wait linked list element E431, and the relevant count value (the count field E434) is also updated accordingly. Through this precise association management mechanism, the memory controller 210 is capable of precisely tracking the data distribution and processing status of each command even under conditions of multi-command parallel processing and data consolidation.

In an embodiment, after the cached write data of the target cache unit is successfully written to the memory module 220, the memory controller 210 performs a series of status update operations to maintain the accuracy of the system status. First, the memory controller 210 traverses each command identifier in the target wait linked list corresponding to the target cache unit, and for each command identifier, decrements the value of the cache unit count field E413 of the structure element E410 of the status information table T410 associated therewith by one. This operation reflects that part of the data of the corresponding command has been successfully written to the persistent storage medium and no longer occupies cache resources.

After the decrement operation of the cache unit count field E413 is completed, the memory controller 210 clears the target wait linked list, releasing the relevant resources to prepare for receiving and processing new data. Through the clearing operation, the system ensures that no command identifier remains associated with the cache units that have already been processed, preventing resource occupation and status confusion, while freeing up space for subsequent data processing. The clearing process comprises resetting the head pointer field E432, the tail pointer field E433, and the count field E434 of the wait linked list element E431, so as to restore them to their initial states.

In some embodiments, the number of elements in the wait linked list T430 may be configured as N times the number of chips in the memory module 220 (where N is, for example, 2 or a larger variable parameter), enabling the system to receive new data into another portion of the cache units while one portion of the cache units is performing write operations, thereby achieving more efficient pipelined data processing.

(4) Completion Linked List

The completion linked list T440 is used to record command identifiers corresponding to completed Force Unit Access (FUA) write commands. As shown in FIG. 7, the completion linked list T440 comprises three key fields:

a head pointer field E441 (also referred to as the third head pointer field), configured to point to a first command identifier in the completion linked list T440;

a tail pointer field E442 (also referred to as the third tail pointer field), configured to point to a last command identifier in the completion linked list T440;

a count field E443 (also referred to as the third count field), configured to record a total number of command identifiers included in the completion linked list T440.

In the system of the present disclosure, migration of a command identifier to the completion linked list T440 is subject to strict conditions, ensuring that the migration operation is performed only after a command has been fully processed. Specifically, when a value of the cache unit count field E413 of the target structure element E410 corresponding to the target command identifier in the status information table T410 is decremented to zero (indicating that all cached data has been written to the memory module 220) and the completion flag field E414 of the target structure element E410 is a first value (indicating that all data has been fully cached), the memory controller 210 updates the target command identifier to the tail pointer field E442 of the completion linked list T440, adding the command identifier to the end of the completion linked list T440 (e.g., the tail pointer field) through appropriate pointer operations.

In the final phase of command processing, the memory controller 210 transmits a corresponding success response or error response to the host system 10 based on the value of the error flag field E415 of the command identifier in the status information table T410. After transmitting the response corresponding to the target command identifier to the host system 10, the memory controller 210 performs linked list maintenance operations: removing the target command identifier from the completion linked list T440, and updating the head pointer field E441 of the completion linked list T440 to a next command identifier of the target command identifier. Through this head element removal mechanism, the completion linked list T440 implements a First In, First Out (FIFO) command processing order, ensuring the temporal ordering and integrity of command responses.

This precise completion linked list management mechanism ensures that the memory controller 210 is able to maintain accurate tracking and response to each Force Unit Access (FUA) write command even in complex scenarios involving parallel processing of multiple commands, thereby achieving efficient command processing and cache resource reclamation.

The present disclosure achieves efficient management of Force Unit Access (FUA) write commands through the coordinated operation of these four data structures. A command is first registered in the trigger linked list T420, and then relevant information is recorded in the status information table T410 during data processing. When data is allocated to a cache unit, the command identifier is transferred to the wait linked list T430, and is finally added to the completion linked list T440 after data is successfully written, awaiting response processing.

This design ensures that even in scenarios involving parallel processing of multiple commands and data consolidation, the memory controller is still able to accurately record information on the plurality of phases experienced by the write operation corresponding to each respective command identifier, so as to track the status of each Force Unit Access (FUA) write command, satisfy the strict requirements of the Force Unit Access protocol, improve data write efficiency, reduce write amplification, and extend the service life of the storage device.

By using linked list structures instead of conventional arrays or queues, the present disclosure achieves dynamic command processing capability, enabling flexible adjustment of the processing order according to the execution status of Force Unit Access (FUA) write commands, improving the responsiveness and data processing efficiency of the system. At the same time, the status information table T410 provides centralized state management, simplifying state query and update operations, so as to enable the overall write operation of Force Unit Access (FUA) write commands to operate stably.

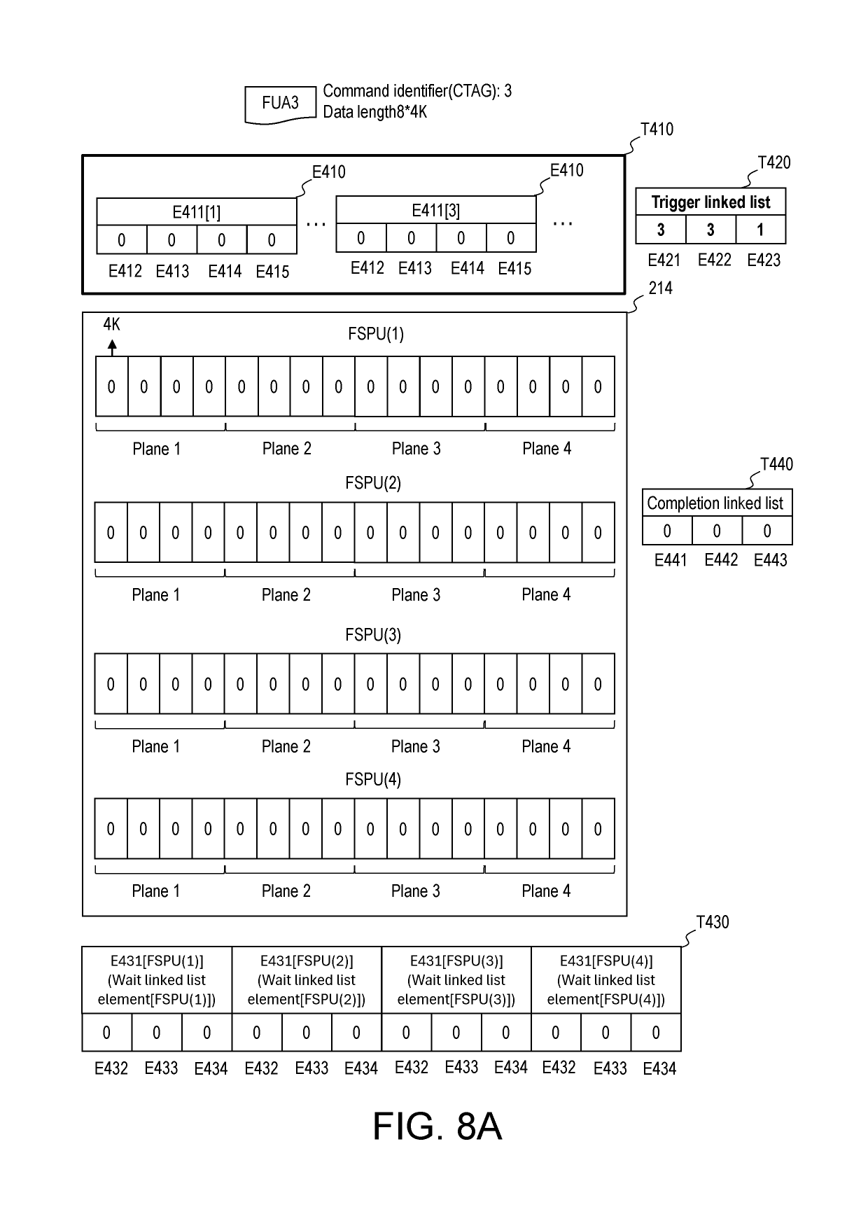

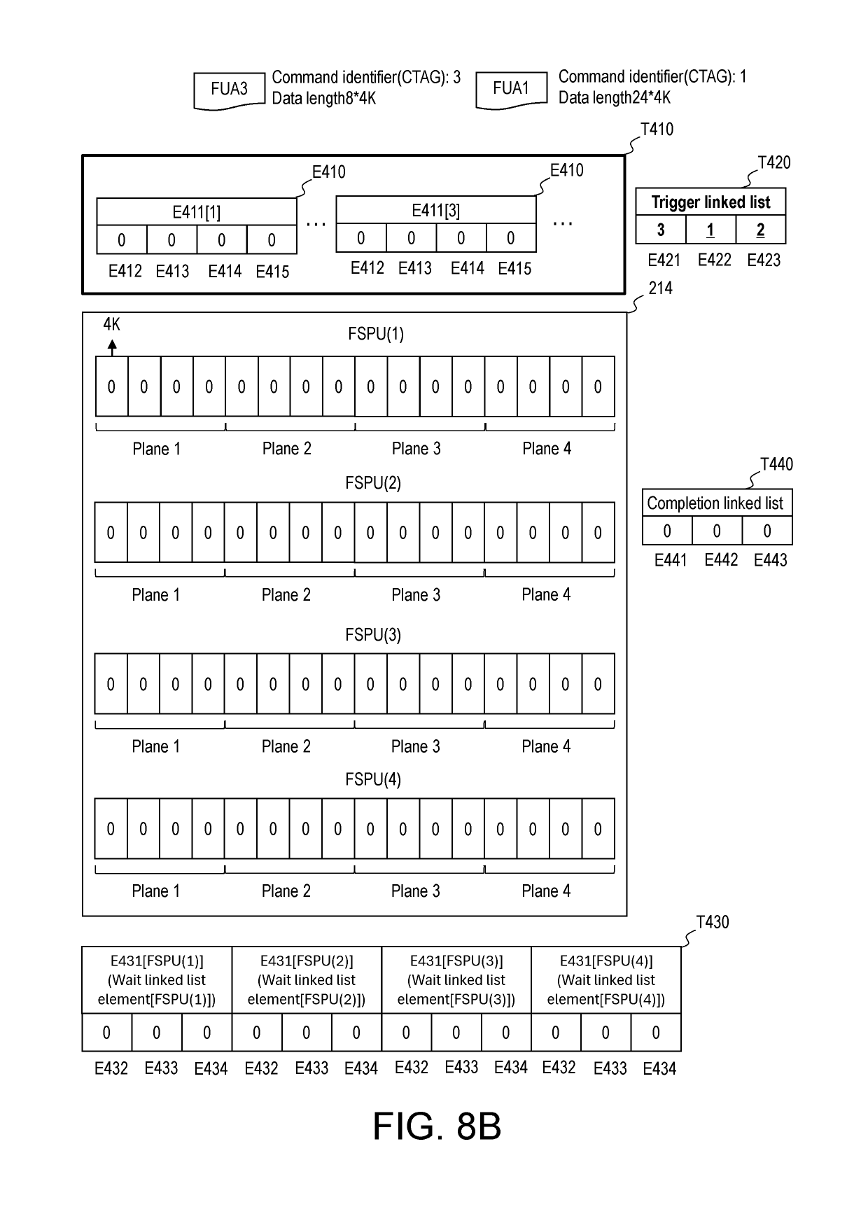

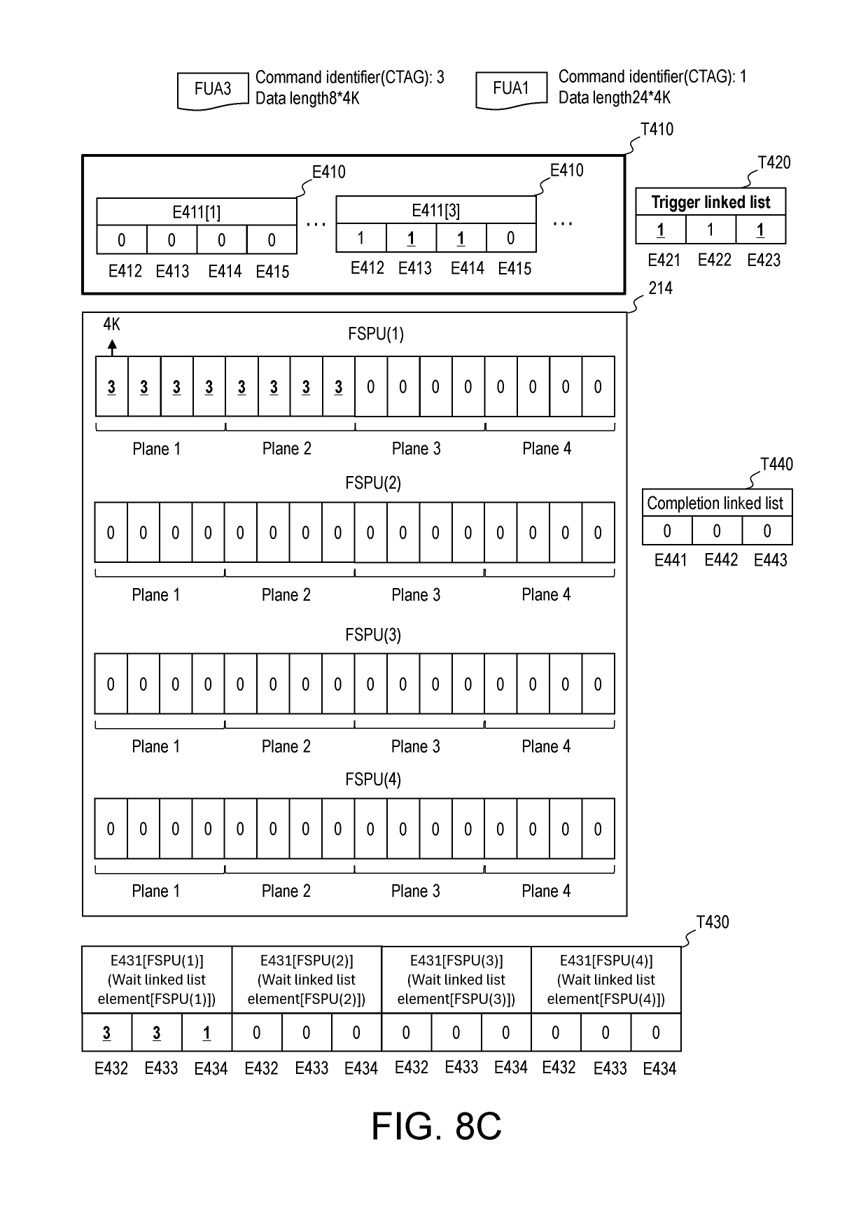

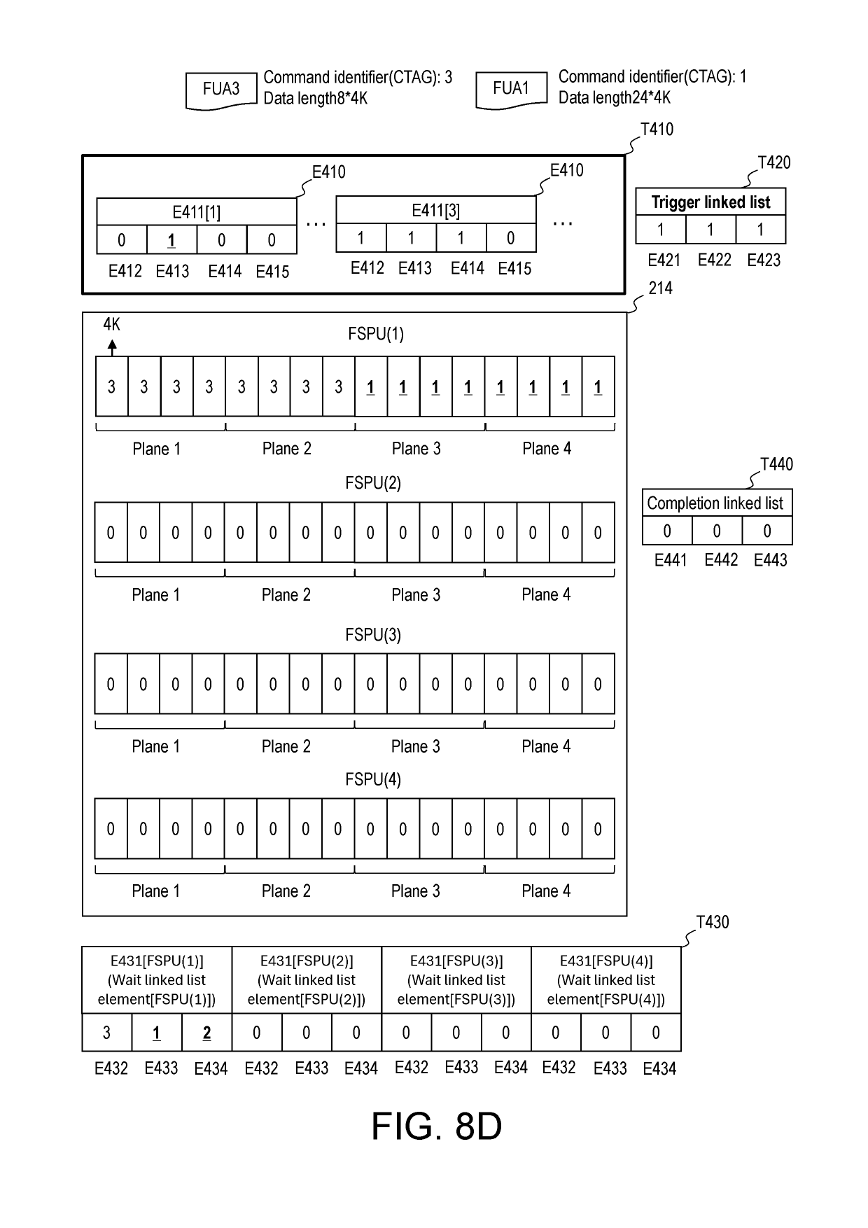

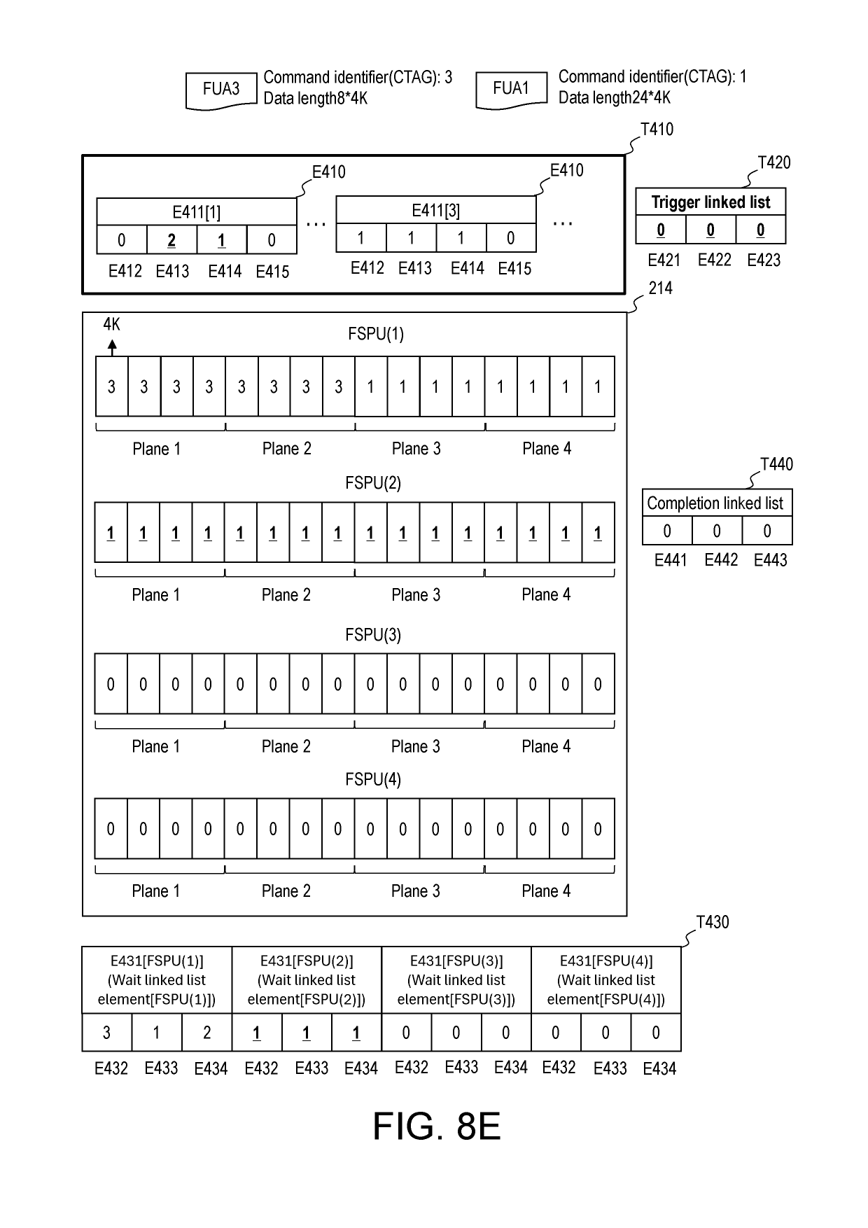

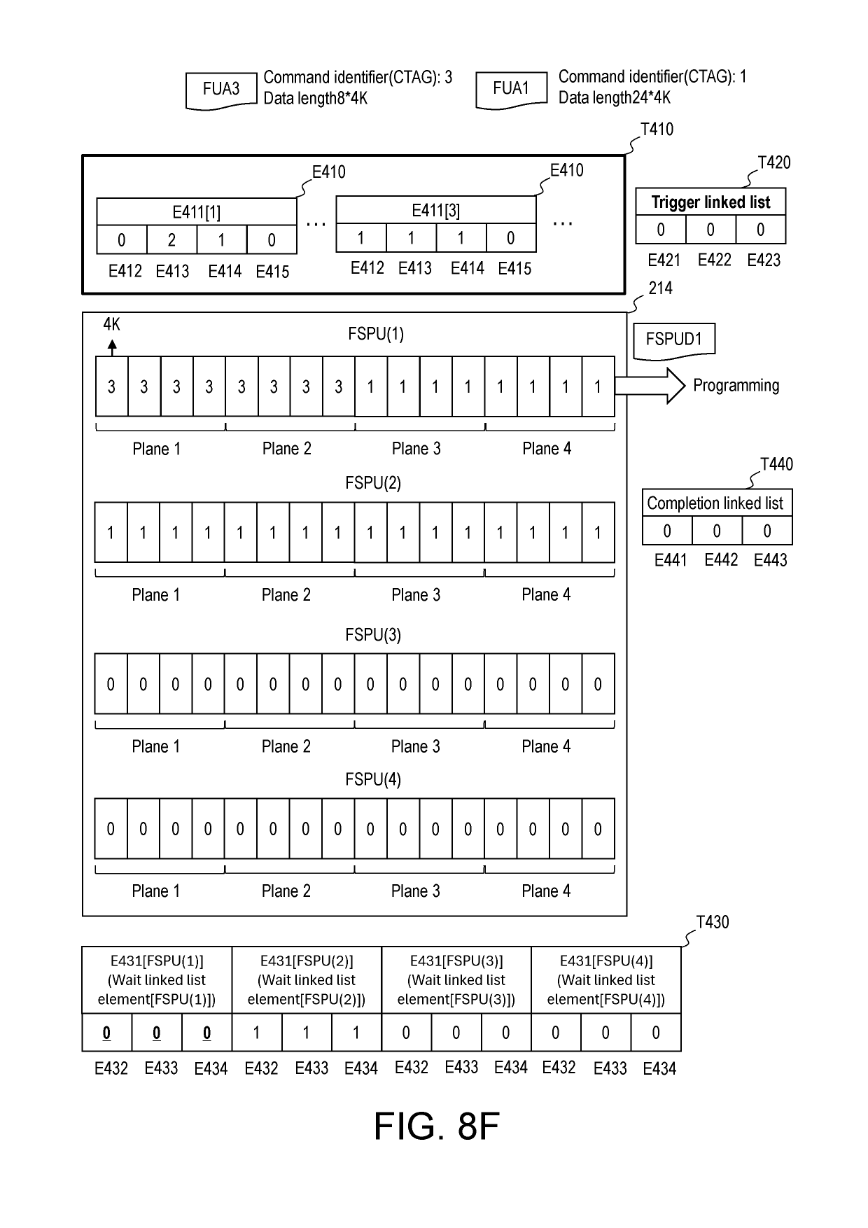

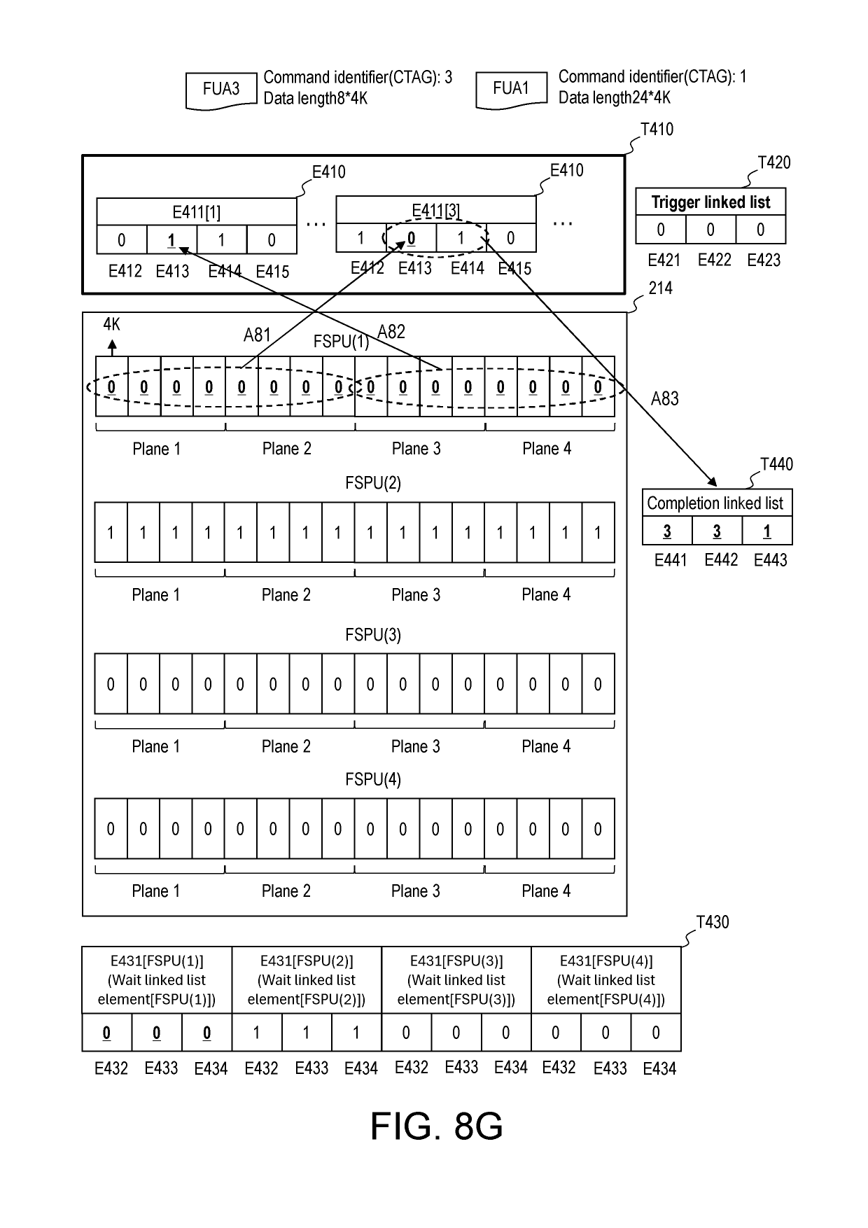

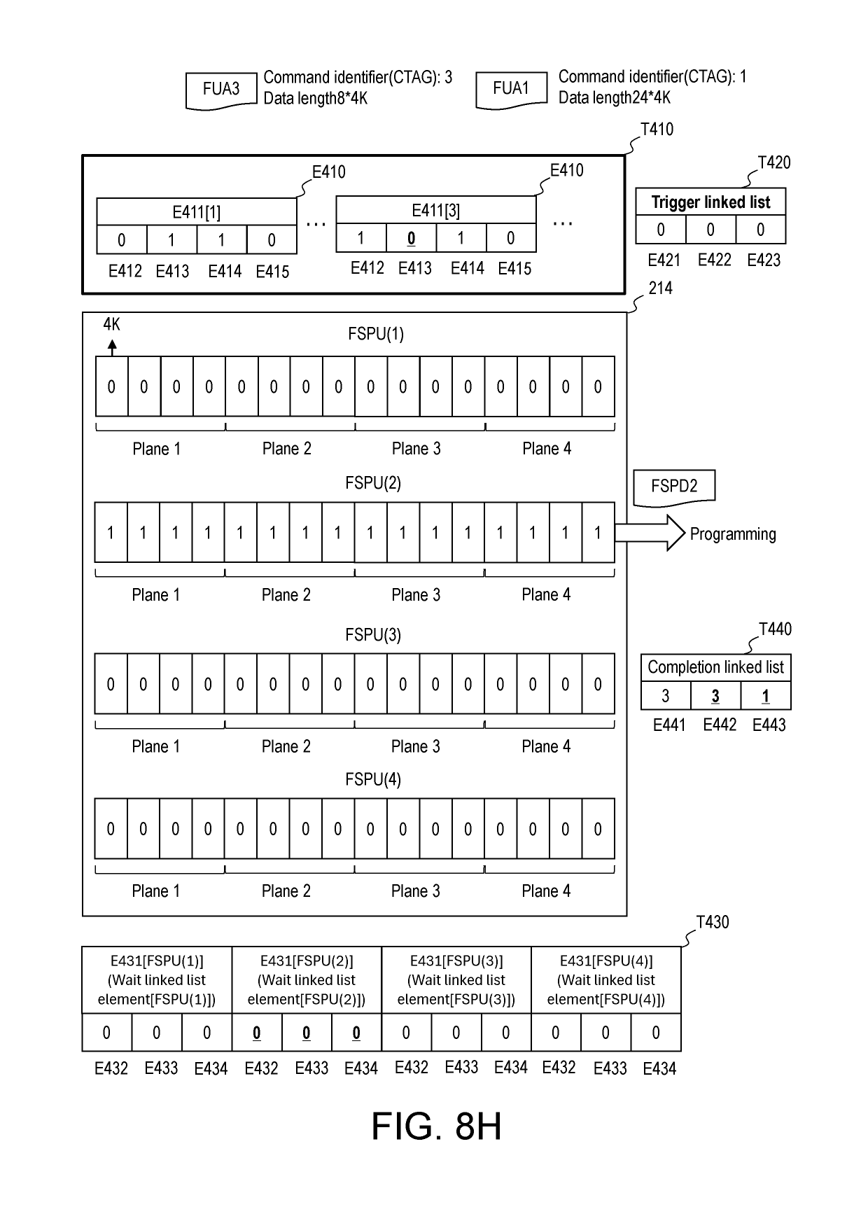

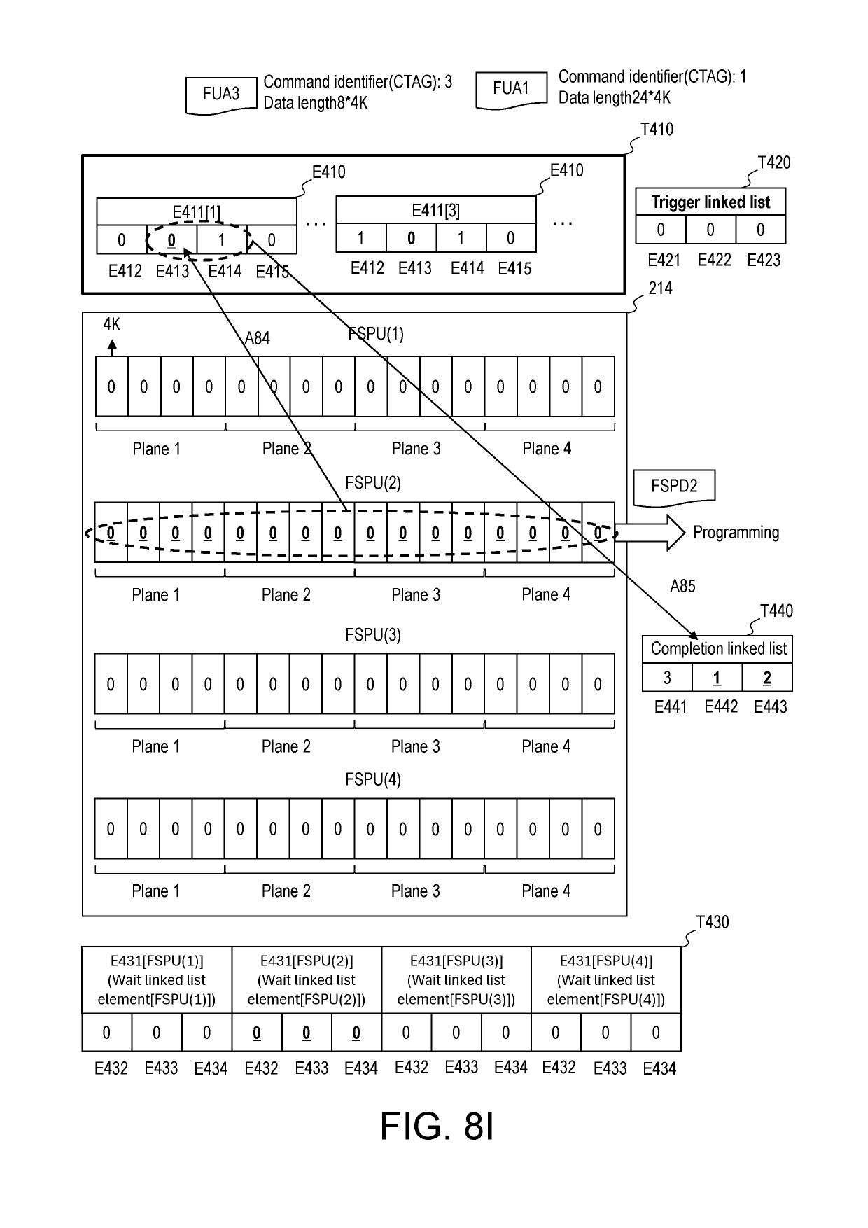

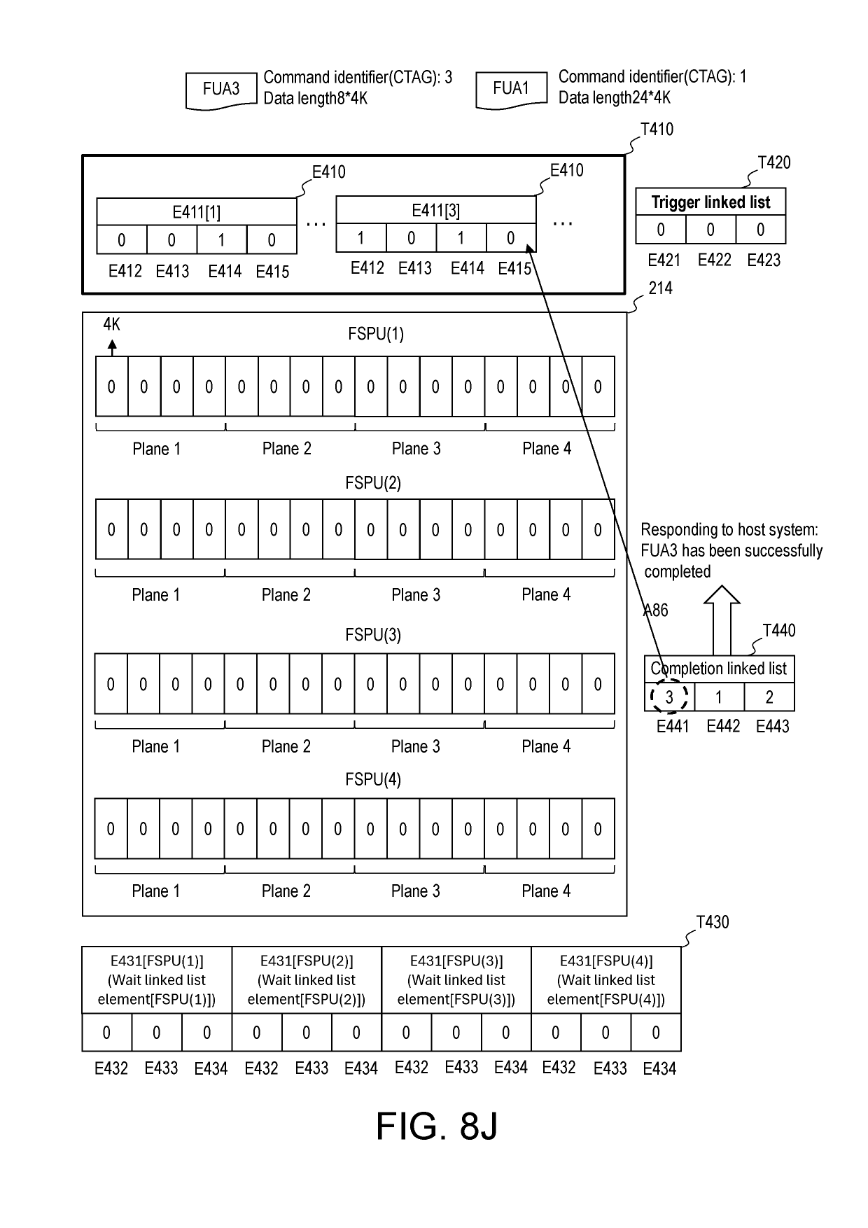

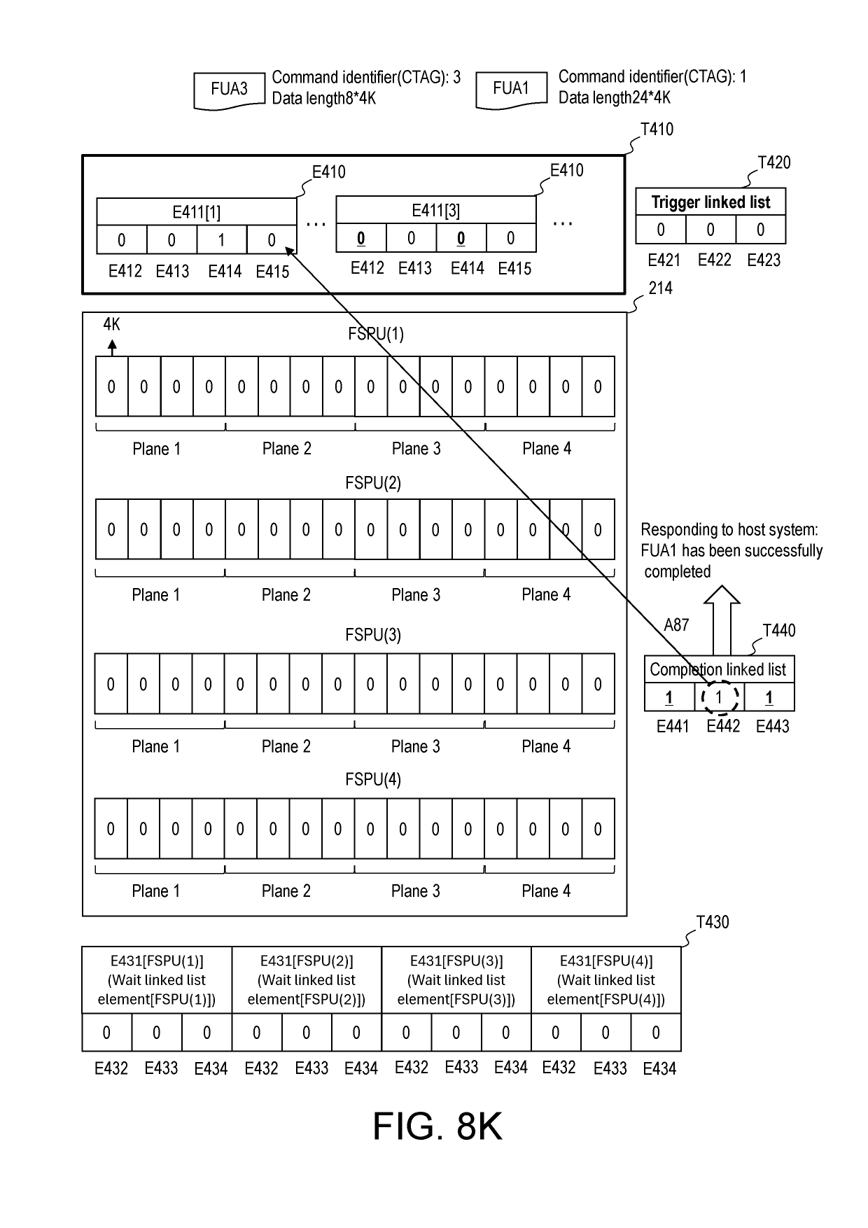

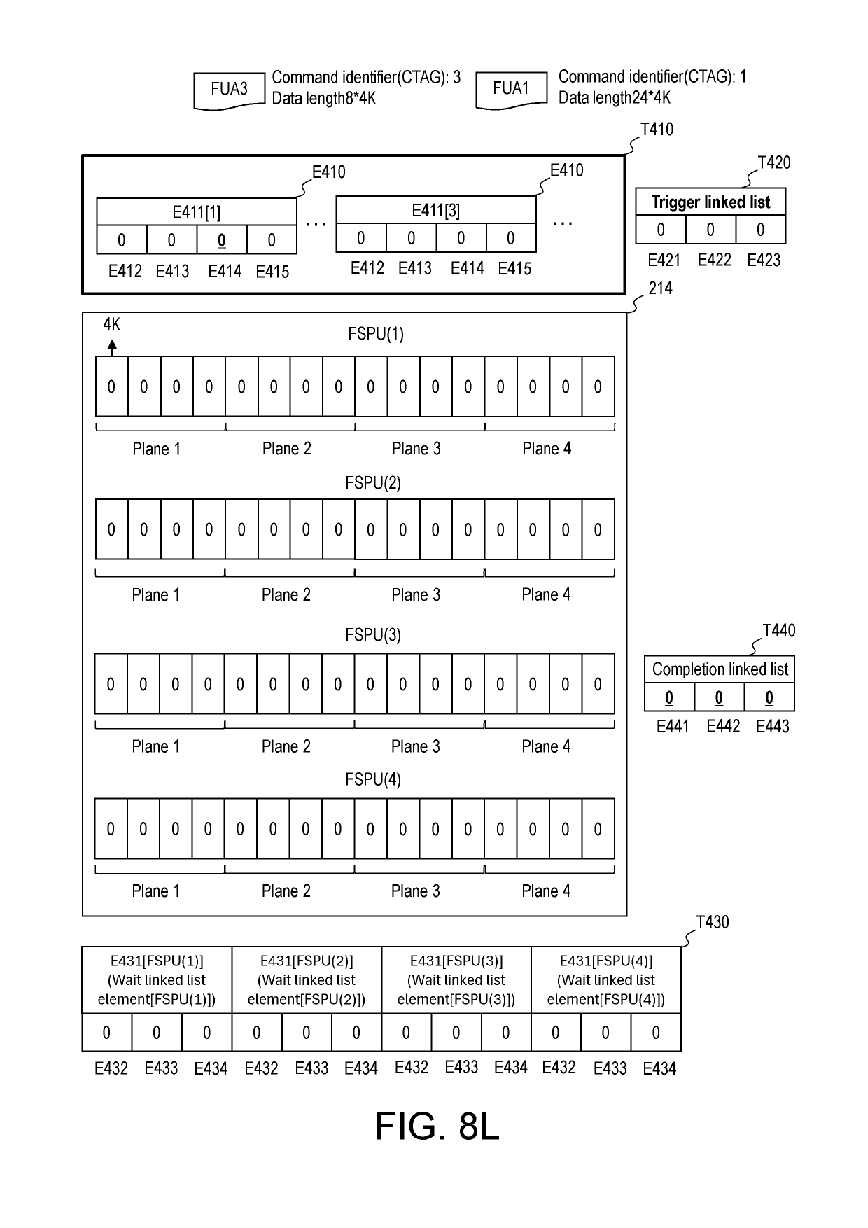

FIG. 8A through FIG. 8L are a series of schematic diagrams illustrating state changes of respective data structures during a plurality of phases of write operations of a plurality of Force Unit Access (FUA) write commands according to an embodiment of the present disclosure.

In an embodiment, referring to FIG. 8A, when the storage device 20 receives a first Force Unit Access (FUA) write command FUA3 (assuming the command identifier (CTAG) of the command is set to "3" and the data length is 8×4K (i.e., 32KB)), the memory controller 210 immediately initializes the relevant data structures in preparation for subsequent command processing.

For command identifier "3", the corresponding structure element E410 can be identified by structure element index E411[3]. In addition, the four fields of the structure element, namely the next pointer field E412, the cache unit count field E413, the completion flag field E414, and the error flag field E415, are all initialized to zero, indicating that the command has not yet started processing, no cache unit has been allocated, data has not been fully cached, and no error has occurred.

Meanwhile, the memory controller 210 updates the trigger linked list T420, adding command identifier "3" as the first object to be processed. As shown in FIG. 8A, the head pointer field E421 and the tail pointer field E422 of the trigger linked list T420 are both set to "3", and the count field E423 is also set to "1" (indicating one command, which actually represents a linked list length of 1). Since there is only one command identifier in the trigger linked list T420 at this point, both the head pointer and the tail pointer of the trigger linked list point to the same command identifier.

In addition, the memory controller 210 also prepares for data caching. As shown in FIG. 8A, four cache units FSPU(1), FSPU(2), FSPU(3), and FSPU(4) are partitioned in the buffer memory 214 (here, the total number of cache units is set to twice the number of chips in the memory module), and each cache unit is further divided into four plane regions corresponding to physical pages of Plane 1 through Plane 4, respectively, for parallel data processing. In the present embodiment, each chip is assumed to comprise 4 planes, with a physical page size of 16 KB per plane, so each cache unit has a size of 4 × 16 KB = 64 KB. All cache sub-units in each cache unit (each assumed to be 4 KB in size for ease of illustration) are initialized to zero, indicating that no data has been stored yet.

On the other hand, the elements of the wait linked list T430 are also in an initial state. FIG. 8A illustrates four wait linked list elements E431[FSPU(1)] through E431[FSPU(4)], corresponding to the four cache units FSPU(1) through FSPU(4), respectively. The head pointer field E432, the tail pointer field E433, and the count field E434 of each wait linked list element E431 are all initialized to zero, indicating that no command has been associated with any cache unit.

Similarly, the completion linked list T440 is also in an idle state, with its head pointer field E441, tail pointer field E442, and count field E443 all set to zero, indicating that no command has completed processing.

In this initial phase, the command FUA3 has been recognized and recorded by the system, but its data has not yet undergone caching or write operations, and is in a state of awaiting processing.

Next, referring to FIG. 8B, when the storage device 20 receives the second Force Unit Access (FUA) write command FUA1 (the command identifier (CTAG) of the command is set to "1", and the data length is 24 × 4K (i.e., 96 KB)), the memory controller 210 performs a series of operations to update the relevant data structures.

First, the memory controller 210 initializes the corresponding structure element E410 in the status information table T410 for command identifier "1", which may be identified by structure element index E411[1]. Similar to the previous processing of the FUA3 command, the four fields of the structure element, namely the next pointer field E412, the cache unit count field E413, the completion flag field E414, and the error flag field E415, are all initialized to zero, indicating that the command has not yet started processing.

Next, the memory controller 210 updates the trigger linked list T420, adding command identifier "1" to the linked list. Since command identifier "3" already exists in the trigger linked list T420, the memory controller 210 updates the next pointer field E412 of the structure element corresponding to command identifier "3" in the status information table T410 to "1", establishing a link from command "3" to command "1". Meanwhile, the tail pointer field E422 of the trigger linked list T420 is updated to "1", indicating that command identifier "1" is now the last element in the trigger linked list T420, while the head pointer field E421 remains at "3", indicating that command identifier "3" is still the first element in the linked list. In addition, the count field E423 is updated to "2", reflecting that there are now two command identifiers in the trigger linked list T420.

At this point, the cache units FSPU(1) through FSPU(4) in the buffer memory 214 remain unused, with all cache sub-units set to zero, indicating that storage of data for any command has not yet begun. Similarly, the head pointer field E432, the tail pointer field E433, and the count field E434 of the four wait linked list elements E431[FSPU(1)] through E431[FSPU(4)] of the wait linked list T430 all remain at zero, indicating that no FUA write command has been associated with any cache unit.

The completion linked list T440 also continues to remain in an idle state, with its head pointer field E441, tail pointer field E442, and count field E443 all set to zero, indicating that no command has completed processing.

At this stage, the storage device 20 has received and recorded two Force Unit Access (FUA) write commands (FUA3 and FUA1), which are linked in the trigger linked list T420 in the order of reception, awaiting subsequent processing. The command FUA3, as the first received command, will be processed with priority, while the command FUA1 will be processed thereafter. This linked-list-based command management mechanism enables the memory controller 210 to process commands according to the First In, First Out (FIFO) principle, ensuring the orderliness of command processing.

Next, referring to FIG. 8C, the memory controller 210 begins processing the Force Unit Access (FUA) write command (FUA3) with command identifier "3", caching its write data into the cache unit FSPU(1), and updating the relevant data structures to reflect this operation.

When the memory controller 210 extracts command identifier "3" from the trigger linked list T420, the memory controller 210 allocates the corresponding 8 × 4K write data to the Plane 1 and Plane 2 regions of the cache unit FSPU(1). As shown in FIG. 8C, the first 8 cache sub-units of the cache unit FSPU(1) are marked as "3", indicating that these positions have been occupied by the data of command identifier "3".

Meanwhile, the memory controller 210 updates the structure element E410 corresponding to command identifier "3" in the status information table T410 (corresponding to structure element number E411[3]). Specifically, the cache unit count field E413 is updated to "1", indicating that the data of the command is now distributed across one cache unit; the completion flag field E414 is updated to "1", indicating that all write data corresponding to command identifier "3" has been fully cached.

After completing the data caching operation, the memory controller 210 updates the trigger linked list T420. Since all data of command identifier "3" has been fully cached, the memory controller 210 removes it from the trigger linked list T420, and updates the head pointer field E421 to "1" by way of the value "1" of the next pointer field of the structure element E411[3] corresponding to command identifier "3", indicating that command identifier "1" is now the first element in the trigger linked list. The tail pointer field E422 remains at "1", while the count field E423 is updated to "1", reflecting that only one command identifier now remains in the trigger linked list T420.

Meanwhile, the memory controller 210 updates the wait linked list element E431[FSPU(1)] in the wait linked list T430 corresponding to the cache unit FSPU(1). The head pointer field E432 and the tail pointer field E433 of the wait linked list element are both set to "3", indicating that the command identifier "3" is the only command associated with the cache unit; the count field E434 is set to "1", indicating that the cache unit currently has one command identifier associated with it. The wait linked list elements corresponding to other cache units remain in an unused state, with their head pointer fields E432, tail pointer fields E433, and count fields E434 all being "0".

The completion linked list T440 remains idle at this stage, with its head pointer field E441, tail pointer field E442, and count field E443 all being "0", indicating that no command has completed the entire processing flow yet.

Next, referring to FIG. 8D, the memory controller 210 continues to perform data processing operations, caching a portion of the write data corresponding to the command identifier "1" into the remaining space of the cache unit FSPU(1), and updating the states of the respective data structures accordingly.

In the previous stage, the Plane 1 and Plane 2 areas of the cache unit FSPU(1) were used to store the data of the command identifier "3". Now, the memory controller 210 extracts the command identifier "1" from the trigger linked list T420 and begins processing the corresponding Force Unit Access (FUA) write command FUA1. Since the data volume corresponding to the command identifier "1" is relatively large (24×4K), the memory controller 210 first allocates a portion of the data to the remaining space of the cache unit FSPU(1), namely the Plane 3 and Plane 4 areas. As shown in FIG. 8D, the last 8 cache sub-units of the cache unit FSPU(1) are marked as "1" (bold and underlined), indicating that these positions are now occupied by a portion of the data of the command identifier "1".

As data allocation proceeds, the memory controller 210 updates the structure element E410 corresponding to the command identifier "1" (corresponding to structure element number E411[1]) in the status information table T410. Specifically, the cache unit count field E413 is updated to "1" (bold and underlined), indicating that a portion of the data of the command is now distributed across one cache unit. Since the data of the command identifier "1" has not been fully cached (only 8 4K sub-units have been used, while the total data volume is 24×4K), the completion flag field E414 remains at "0". In an embodiment, the memory controller 210 may maintain a write data register to accurately record the caching status of the write data for each Force Unit Access (FUA) write command. For example, the write data register allocates a bitmap structure for each command identifier, wherein each bit corresponds to a data block of a specific size (e.g., 4K). When the corresponding data block is successfully cached, the corresponding bit is set to a specific value (e.g., "1"). By checking the status of the write data register, the memory controller 210 is able to accurately calculate the difference between the cached data volume (8×4K) and the total data volume (24×4K) of the command identifier "1", , so as to determine that 16×4K of write data has not yet been cached. This fine-grained data tracking mechanism enables the memory controller 210 to efficiently manage the data caching process, providing the necessary decision-making basis for subsequent caching operations, while ensuring that all write data is correctly processed to meet the strict requirements of the Force Unit Access protocol.

Meanwhile, the memory controller 210 also updates the wait linked list element E431[FSPU(1)] in the wait linked list T430 corresponding to the cache unit FSPU(1). Since the data of two commands is now stored in the cache unit, the state of the wait linked list element needs to be updated accordingly. The head pointer field E432 remains at "3", indicating that the command identifier "3" is still the first command associated with the cache unit; the tail pointer field E433 is updated to "1", indicating that the command identifier "1" is now the last command associated with the cache unit; the count field E434 is updated to "2", reflecting that the cache unit currently has two command identifiers associated with it.

It is worth noting that at this point, the cache unit FSPU(1) has been completely filled (all 16 4K cache sub-units have been used), forming a complete cache unit. In an embodiment, the memory controller 210 prepares to perform the corresponding programming operation on the cache unit that has been completely filled.

The state of the trigger linked list T420 remains unchanged, with its head pointer field E421 and tail pointer field E422 both being "1" and the count field E423 being "1", indicating that the command identifier "1" is still waiting in the trigger linked list for further processing. Since the data of the command identifier "1" has not been fully cached, it will not be removed from the trigger linked list T420.

The completion linked list T440 remains idle, with its head pointer field E441, tail pointer field E442, and count field E443 all being "0", indicating that no command has completed the entire processing flow yet.

Next, referring to FIG. 8E, the memory controller 210 continues to process the remaining write data of the Force Unit Access (FUA) write command FUA1 corresponding to the command identifier "1" by caching the data into the cache unit FSPU(2), while completing the updates to the relevant data structures.

After the cache unit FSPU(1) is completely filled, the memory controller 210 continues to extract the command identifier "1" from the trigger linked list T420 and begins processing its remaining write data. As shown in FIG. 8E, the memory controller 210 allocates the remaining write data corresponding to the command identifier "1" to the cache unit FSPU(2). Since the total data volume of the command identifier "1" is 24×4K and 8×4K of data has already been stored in the cache unit FSPU(1), the memory controller 210 allocates all of the remaining 16×4K data to the cache unit FSPU(2). All 16 cache sub-units of the cache unit FSPU(2) are marked as "1", indicating that these positions have been occupied by the remaining write data of the command identifier "1".

As data allocation is completed, the memory controller 210 updates the structure element E410 corresponding to the command identifier "1" (corresponding to structure element number E411[1]) in the status information table T410. Specifically, the cache unit count field E413 is updated to "2" (bold and underlined), indicating that the data of the command is now distributed across two cache units; and the completion flag field E414 is updated to "1", indicating that all write data of the command identifier "1" has been fully cached.

Since all data of the command identifier "1" has been fully cached, the memory controller 210 removes it from the trigger linked list T420. As shown in FIG. 8E, the head pointer field E421, tail pointer field E422, and count field E423 of the trigger linked list T420 are all updated to "0", indicating that the trigger linked list T420 is now empty and there are no pending commands.

Meanwhile, the memory controller 210 updates the wait linked list element E431[FSPU(2)] in the wait linked list T430 corresponding to the cache unit FSPU(2). The head pointer field E432 and the tail pointer field E433 of the wait linked list element are both set to "1", indicating that the command identifier "1" is the only command associated with the cache unit; the count field E434 is set to "1", indicating that the cache unit currently has one command identifier associated with it.

At this point, the memory controller 210 is ready to perform programming operations on the completely filled cache units FSPU(1) and FSPU(2) (in some embodiments, once the cache unit FSPU(1) is filled, the cached data may be written in parallel to the plurality of planes of the memory module 220 through the multi-plane write mechanism). The programming operation will write the cached data in parallel to the plurality of planes of the memory module 220 through the multi-plane write mechanism, so as to achieve efficient data writing. The parallel write operation avoids the write amplification problem in conventional methods through data consolidation.

The completion linked list T440 remains idle at this phase, with its head pointer field E441, tail pointer field E442, and count field E443 all set to "0", indicating that no command has completed the entire processing flow, because although the data has been fully cached, it has not yet been successfully written to the memory module 220.

Next, referring to FIG. 8F, the memory controller 210 performs a program operation on cache unit FSPU(1) to write the cached write data FSPD1 to the memory module 220, and correspondingly updates each data structure to reflect the system state after the completion of this operation.

When the data in cache unit FSPU(1) is ready, the memory controller 210 triggers a program operation to simultaneously write the write data FSPD1 in FSPU(1), which contains partial data of command identifier "3" and command identifier "1", to the corresponding physical locations of the memory module 220 through the multi-plane write mechanism. As shown by the arrow on the right side of FIG. 8F, the program operation realizes the permanent storage transfer of data from the buffer memory 214 to the memory module 220.

After the program operation is completed, the memory controller 210 updates the wait linked list element E431[FSPU(1)] in the wait linked list T430 corresponding to cache unit FSPU(1). Given that the data of the cache unit has been successfully written to the memory module 220, the memory controller 210 clears the wait linked list element, resetting its head pointer field E432, tail pointer field E433, and count field E434 all to "0" (bolded and underlined), indicating that the cache unit is no longer associated with any command. This operation releases cache resources, making cache unit FSPU(1) and the corresponding wait linked list element E431[FSPU(1)] available for subsequent data caching operations.

Meanwhile, the memory controller 210 updates the status of the command identifiers associated with the data in FSPU(1) in the status information table T410. For command identifier "3", because one of its associated cache units FSPU(1) has performed a program operation to program the write data corresponding to command identifier "3" to the memory module 220, cache unit FSPU(1) will be cleared. Therefore, the memory controller 210 decrements the value of its cache unit count field E413 from "1" to "0", indicating that there are currently 0 cache units storing write data associated with command identifier "3". Similarly, for command identifier "1", since part of its data (8×4K) is stored in FSPU(1) and another part (16×4K) is stored in FSPU(2), the memory controller 210 decrements the value of its cache unit count field E413 from "2" to "1", indicating that the data of the command is now distributed in only one cache unit (i.e., FSPU(2)).

Next, referring to FIG. 8G, after the data in cache unit FSPU(1) is successfully written to the memory module 220, the memory controller 210 performs a command completion status check and updates the status information table and the completion linked list.

As shown in FIG. 8G, when the memory controller 210 detects that the cache unit count field E413 of command identifier "3" has been decremented to "0" and the completion flag field E414 is "1", the memory controller 210 performs a series of operations to update the system state. Arrow A81 indicates that the memory controller 210 checks the completion flag field E414 in the structure element E410 corresponding to command identifier "3", confirming that its value is "1", indicating that all data of the command has been fully cached.

Subsequently, as shown by arrow A82, the memory controller 210 checks the cache unit count field E413 in the structure element E410 corresponding to command identifier "3", confirming that its value is "0" (bolded and underlined), indicating that all data of the command has been successfully written to the memory module 220 and no longer occupies any cache unit. Meanwhile, the memory controller 210 also confirms that the completion flag field E414 of the structure element is "1", indicating that all data of the command was in a fully cached state. That is to say, at this point, the memory controller 210 can determine that all write data corresponding to command identifier "3" has been both fully cached and successfully written to the memory module 220.

Based on the above check results, as shown by arrow A83, the memory controller 210 adds command identifier "3" to the completion linked list T440. Specifically, the memory controller 210 updates both the head pointer field E441 and the tail pointer field E442 of the completion linked list T440 to "3" (bolded and underlined), indicating that command identifier "3" is the first and only element in the completion linked list; the count field E443 is also set to "1" (bolded and underlined), indicating that the completion linked list currently contains one command identifier.

In addition, cache unit FSPU(1) is also completely cleared, so as to make cache unit FSPU(1) available for subsequent data caching operations. Cache unit FSPU(2) still retains the data of command identifier "1", awaiting the execution of the program operation.

Through this series of status checks and completion linked list update operations, the memory controller 210 achieves tracking of the processing status of Force Unit Access (FUA) write commands. In particular, when all data of a command has been successfully written to the memory module 220 and no longer occupies any cache unit, the command identifier is added to the completion linked list T440, in preparation for subsequently transmitting a command completion response to the host system 10.

Referring to FIG. 8H, the memory controller 210 performs a program operation on cache unit FSPU(2) to write the cached write data FSPD2 to the memory module 220, and updates the relevant data structures to reflect the system state after this operation.

As shown in FIG. 8H, the memory controller 210 triggers a program operation on cache unit FSPU(2) to simultaneously write the remaining write data FSPD2 of command identifier "1" stored therein to the corresponding physical locations of the memory module 220 through the multi-plane write mechanism. The program operation transfers the data of all 16 cache sub-units in cache unit FSPU(2) corresponding to Plane 1 through Plane 4 to the memory module 220, completing the transfer of all write data of command identifier "1" from the buffer memory 214 to the memory module 220.

After the program operation is completed, the memory controller 210 updates the wait linked list element E431[FSPU(2)] in the wait linked list T430 corresponding to cache unit FSPU(2). Since the data of the cache unit has been successfully written to the memory module 220, the memory controller 210 clears the wait linked list element, resetting its head pointer field E432, tail pointer field E433, and count field E434 all to "0" (bolded and underlined), indicating that the cache unit and the corresponding wait linked list element E431[FSPU(2)] are no longer associated with any command. This operation releases cache resources.

Next, referring to FIG. 8I, after the data of cache unit FSPU(2) is successfully written to the memory module 220, the memory controller 210 performs a command completion status check and updates the status information table and the completion linked list.

As shown in FIG. 8I, after the data in cache unit FSPU(2) is programmed to the memory module 220, the cache unit FSPU(2) is cleared. At the same time, the memory controller 210 updates the status of the structure element E410 corresponding to the command identifier "1" in the status information table T410 (corresponding to structure element number E411[1]). Since the cache unit FSPU(2) associated with the command identifier "1" has performed the programming operation, programming the corresponding write data to the memory module 220, the cache unit count field E413 is decremented from "1" to "0", indicating that no cache unit currently stores write data associated with the command identifier "1".

At this point, the memory controller 210 detects that the cache unit count field E413 of the command identifier "1" has been decremented to "0" and the completion flag field E414 is "1", indicating that all data of the command has been completely cached and successfully written to the memory module 220.

The memory controller 210 checks the processing status of the command identifier "1". As shown by arrow A85, the memory controller 210 first checks the cache unit count field E413 of the structure element E410 corresponding to the command identifier "1" in the status information table T410, confirming that its value is "0" (in bold with a dashed box), indicating that no cache unit stores write data associated with the command identifier. At the same time, the memory controller 210 also confirms that the completion flag field E414 is "1", indicating that all data of the command has been completely cached. That is, at this point, the memory controller 210 can determine that all write data corresponding to the command identifier "1" has been written to the memory module 220 while being completely cached. Based on the above check results, the memory controller 210 adds the command identifier "1" to the completion linked list T440. At this point, the completion linked list T440 already contains the command identifier "3". The memory controller 210 updates the structure of the completion linked list T440, setting the tail pointer field E442 to "1" to indicate that the command identifier "1" is now the last element in the linked list, and updating the count field E443 to "2" to reflect that the completion linked list currently contains two command identifiers. The head pointer field E441 remains "3", indicating that the command identifier "3" is still the first element in the linked list.

In addition, the cache unit FSPU(2) is represented by a dashed box to indicate that all internal cache sub-units are reset to "0", and the memory controller 210 updates all fields of the wait linked list element E431(FSPU(2)) to "0", indicating that the cache unit FSPU(2) is currently not associated with any FUA write command.

Through this series of status checks and completion linked list update operations, the memory controller 210 achieves tracking of the processing status of Force Unit Access (FUA) write commands. In particular, when all data of a command has been successfully written to the memory module 220 and no longer occupies any cache unit, the command identifier is added to the completion linked list T440, in preparation for subsequently transmitting a command completion response to the host system 10.

In the completion linked list T440, the command identifiers "3" and "1" correspond to Force Unit Access (FUA) write commands FUA3 and FUA1, respectively, and all of their data has been successfully written to the memory module 220. Since the command identifier "3" was added to the completion linked list T440 before the command identifier "1", the memory controller 210 processes the responses to the commands in the order they were added.

For example, referring to FIG. 8J, when the completion linked list T440 contains command identifiers, the memory controller 210 performs a command completion response operation, transmitting the processing result of the corresponding command to the host system 10.

As shown in FIG. 8J, the memory controller 210 begins processing the command identifiers in the completion linked list T440, preparing to transmit responses to the host system 10. Specifically, the memory controller 210 first retrieves the first command identifier "3" (with a dashed box) from the head pointer field E441 of the completion linked list T440. This command identifier corresponds to Force Unit Access (FUA) write command FUA3, and all of its data has been successfully written to the memory module 220.

Before transmitting the response, as shown by arrow A86, the memory controller 210 checks the error flag field E415 of the structure element E410 corresponding to the command identifier "3" in the status information table T410 (corresponding to structure element number E411[3]). This check confirms that the value of the error flag field E415 is "0", indicating that no error occurred during command processing. Based on this check result, the memory controller 210 transmits a "success" response to the host system 10, indicating that Force Unit Access (FUA) write command FUA3 has been successfully completed.

This completion-linked-list-based command response mechanism ensures that the memory controller 210 transmits the corresponding responses to the host system 10 sequentially in the order that the commands are completed. For Force Unit Access (FUA) write commands, a success response is transmitted only after all of their data is indeed written to the memory module 220, thereby satisfying the strict requirements of the Force Unit Access write protocol.

In addition, by checking the error flag field E415 before transmitting the response, the memory controller 210 can accurately reflect the actual result of command processing, ensuring that the host system 10 receives accurate operation status information. If an error occurs during command processing (for example, a write failure), the error flag field E415 is set to the corresponding value, and the memory controller 210 transmits an "error" response, rather than a success response, to the host system 10 accordingly.

Next, referring to FIG. 8K, the memory controller 210 continues to process the next command identifier in the completion linked list T440 and completes the response operation for command FUA1.

As shown in FIG. 8K, after transmitting the success response for command FUA3 corresponding to the command identifier "3", the memory controller 210 removes the command identifier "3" from the completion linked list T440 by updating the head pointer field E441 of the completion linked list T440 to the next command identifier pointed to by the next pointer of the command identifier "3" (i.e., the command identifier "1"), continuing to process other commands in the linked list. At the same time, the memory controller 210 clears the structure element E410 corresponding to the command identifier "3" in the status information table T410, resetting its next pointer field E412, cache unit count field E413, completion flag field E414, and error flag field E415 all to "0", releasing resources for processing new commands.

Next, the memory controller 210 begins processing the current head command identifier "1" in the completion linked list T440. As shown by arrow A87, the memory controller 210 checks the error flag field E415 of the structure element E410 corresponding to the command identifier "1" in the status information table T410 (corresponding to structure element number E411[1]). This check confirms that the value of the error flag field E415 is "0", indicating that no error occurred during command processing. Based on this check result, the memory controller 210 transmits a success response to the host system 10, indicating that Force Unit Access (FUA) write command FUA1 has been successfully completed.

After the memory controller 210 has processed all of the commands in the completion linked list T440, the corresponding resources are released, and the memory controller 210 is ready to receive and process new Force Unit Access (FUA) write commands.

After completing responses to the host system 10 for all FUA write commands, referring to FIG. 8L, for example, after the memory controller 210 completes processing of command identifier "1", a system flush operation is performed to reset the relevant data structures to their initial states, so as to prepare for receiving and processing new Force Unit Access (FUA) write commands.

As shown in FIG. 8L, after transmitting the success response for command identifier "1", the memory controller 210 performs a series of flush operations. First, the memory controller 210 removes command identifier "1" from the completion linked list T440, and resets the head pointer field E441, the tail pointer field E442, and the count field E443 of the completion linked list T440 to "0", indicating that the completion linked list T440 is now empty and no longer contains any command identifier.

At the same time, the memory controller 210 clears all fields of the structure element E410 (corresponding to structure element number E411[1]) corresponding to command identifier "1" in the status information table T410, resetting its next pointer field E412, the cache unit count field E413, the completion flag field E414, and the error flag field E415 to "0". In particular, in FIG. 8L, the completion flag field E414 is reset from "1" in FIG. 8K to "0", indicating that the structure element has been fully cleared and is available for processing new commands.

Through this series of flush operations, the memory controller 210 resets the entire system state back to the initial state, so as to prepare for receiving and processing new Force Unit Access (FUA) write commands. This complete resource reclamation and state reset mechanism ensures that the storage device 20 can continuously process other write requests from the host system 10, maintaining stable operation of the system.

This flush step is the final phase of the Force Unit Access (FUA) write command optimization method provided by the present disclosure, marking the end of a complete processing cycle. At this point, all data of the two Force Unit Access (FUA) write commands FUA3 and FUA1 has been successfully written to the memory module 220, and the corresponding success responses have been transmitted to the host system 10, satisfying the requirements of the Force Unit Access (FUA) write protocol. Meanwhile, all system resources used to process these commands, including data structures and cache units, have been released and reset, providing sufficient resource support for subsequent command processing.

This complete processing flow, from command reception, data caching, and write execution to command response and resource release, embodies the Force Unit Access (FUA) write command optimization method provided by the present disclosure, which can efficiently utilize the multi-plane write mechanism to satisfy the protocol requirements of Force Unit Access (FUA) writes, providing an effective technical solution for storage systems that need to process a large number of Force Unit Access (FUA) write commands.

The present embodiment further provides a computer program product comprising computer-readable code, or a non-volatile computer-readable storage medium carrying computer-readable code, wherein when the computer-readable code runs in a processor, the processor executes the steps of the data writing method described above. The computer program product may be implemented specifically by hardware, firmware, software, or a combination thereof. In an optional embodiment, the computer program product is embodied as a computer storage medium; in another optional embodiment, the computer program product is embodied as a software product, such as a Software Development Kit (SDK), and so on.

Based on the foregoing, the data writing method and the memory controller provided by the present disclosure can optimize the processing flow of Force Unit Access (FUA) write operations. By maintaining four efficient data structures, namely the status information table, the trigger linked list, the wait linked list, and the completion linked list, combined with the multi-plane parallel write mechanism, the present method achieves precise tracking and processing of Force Unit Access (FUA) write commands. The technical solution not only satisfies the strict requirements of the Force Unit Access (FUA) write protocol by ensuring that a success response is transmitted to the host system only after data is successfully written to the non-volatile storage medium, but also reduces write amplification through data consolidation technology, effectively extending the service life of the memory module. Compared with the conventional single-command serial processing approach, the technical solution of the present disclosure, while ensuring data security, achieves dual optimization of storage resource utilization and write efficiency through multi-command data consolidation and parallel processing.

Finally, it should be noted that the foregoing embodiments are provided solely to illustrate the technical solutions of the present disclosure and are not intended to limit the same. Although the present disclosure has been described in detail with reference to the foregoing embodiments, a person of ordinary skill in the art should understand that modifications may still be made to the technical solutions described in the foregoing embodiments, or equivalent substitutions may be made to some or all of the technical features thereof; and such modifications or substitutions do not cause the essence of the corresponding technical solutions to depart from the scope of the technical solutions of the embodiments of the present disclosure.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A data writing method, applied to a storage device configured with a memory module and a buffer memory, the memory module comprising a plurality of chips, and each chip having a plurality of physical blocks grouped into a plurality of planes, wherein the method comprises:
in response to one or more Force Unit Access (FUA) write commands, assigning a unique command identifier to each Force Unit Access (FUA) write command;
recording information on a plurality of phases experienced by a write operation corresponding to each command identifier;
consolidating and caching write data corresponding to one or more command identifiers into cache units corresponding to the plurality of planes in the buffer memory;
when the cache unit is full, writing the cached write data of the cache units to the memory module through a multi-plane write mechanism; and
after all target write data corresponding to a target command identifier are successfully written to the memory module, transmitting a success response to a host system, so as to indicate that the target Force Unit Access (FUA) write command corresponding to the target command identifier has been completed.

2. The data writing method as claimed in claim 1, wherein the plurality of phases comprise a trigger phase, a cache phase, and a completion phase, wherein:
after receiving the target Force Unit Access (FUA) write command corresponding to the target command identifier, a target write operation of the target command identifier enters the trigger phase;
after the target write data corresponding to the target command identifier is consolidated and cached into a target cache unit corresponding to the plurality of planes, the target write operation enters the cache phase,
after all the target write data corresponding to the target command identifier is successfully written from the target cache unit to the memory module through the multi-plane write mechanism, the target write operation enters the completion phase.

3. The data writing method as claimed in claim 2, wherein recording information on the plurality of phases experienced by the write operation corresponding to each command identifier comprises:
establishing a status information table to record general status information of each command identifier;
maintaining a trigger linked list to record the command identifier corresponding to each received Force Unit Access (FUA) write command;
maintaining a wait linked list to record one or more command identifiers corresponding to each cache unit; and
maintaining a completion linked list to record command identifiers corresponding to completed Force Unit Access (FUA) write commands.

4. The data writing method as claimed in claim 3, wherein consolidating and caching write data corresponding to the one or more command identifiers into the cache units corresponding to the plurality of planes in the buffer memory comprises:
extracting one or more first command identifiers from the trigger linked list to consolidate and cache corresponding first write data into a first cache unit, wherein a size of the first write data equals a size of the first cache unit, and the size of the cache unit corresponds to one Flash Super Page of the memory module;
removing the one or more first command identifiers from the trigger linked list; and
updating the one or more first command identifiers to the wait linked list and the status information table.

5. The data writing method as claimed in claim 3, wherein the status information table comprises structure elements in a quantity corresponding to a maximum number of command identifiers, each structure element having a one-to-one correspondence with one of the command identifiers, and each structure element comprising:
a next pointer field, configured to point to a next command identifier following the corresponding command identifier;
a cache unit count field, configured to record a total number of cache units storing write data corresponding to the command identifier;
a completion flag field, configured to indicate whether all write data corresponding to the command identifier has been cached; and
an error flag field, configured to indicate whether an error occurs during writing of the write data corresponding to the command identifier.

6. The data writing method as claimed in claim 3, wherein the trigger linked list comprises:
a first head pointer field, configured to point to a first command identifier in the trigger linked list;
a first tail pointer field, configured to point to a last command identifier in the trigger linked list; and
a first count field, configured to record a total number of command identifiers included in the trigger linked list.

7. The data writing method as claimed in claim 6, wherein after receiving the target Force Unit Access (FUA) write command, the method further comprises:
if the trigger linked list is empty, updating the target command identifier to the first head pointer field and the first tail pointer field of the trigger linked list, and setting the first count field of the trigger linked list to one;
20if the trigger linked list is not empty, updating the next pointer field of the structure element, in the status information table, corresponding to the command identifier pointed to by the current first tail pointer field to the target command identifier, updating the target command identifier to the first tail pointer field of the trigger linked list, and incrementing the value of the first count field of the trigger linked list by one.

8. The data writing method as claimed in claim 3, wherein a total number of wait linked list elements of the wait linked list is configured according to a number of chips in the memory module, and each wait linked list element corresponds to one of the cache units, wherein each wait linked list element comprises:
a second head pointer field, configured to point to a first command identifier associated with the corresponding cache unit;
a second tail pointer field, configured to point to a last command identifier associated with the corresponding cache unit; and
a second count field, configured to record a total number of all command identifiers associated with the corresponding cache unit,
wherein when target write data corresponding to the target command identifier is cached to the target cache unit, the target command identifier is updated to a target wait linked list element associated with the target cache unit, and a value of the cache unit count field of the corresponding structure element in the status information table is incremented by one.

9. The data writing method as claimed in claim 3, wherein after the cached write data of the target cache unit is successfully written to the memory module, the method further comprises:
decrementing, by one, the value of the cache unit count field of the structure element of the status information table associated with each command identifier in the target wait linked list corresponding to the target cache unit; and
clearing the target wait linked list.

10. The data writing method as claimed in claim 3, wherein the completion linked list comprises:
a third head pointer field, configured to point to a first command identifier in the completion linked list;
a third tail pointer field, configured to point to a last command identifier in the completion linked list; and
a third count field, configured to record a total number of command identifiers included in the completion linked list,
wherein when a value of the cache unit count field of a target structure element corresponding to the target command identifier in the status information table is decremented to zero and the completion flag field of the target structure element is a first value, the target command identifier is updated to the completion linked list,
wherein after a success response corresponding to the target command identifier is transmitted to the host system, the target command identifier is removed from the completion linked list, and the third head pointer field of the completion linked list is updated to a next command identifier of the target command identifier.

11. A memory controller for controlling a storage device configured with a memory module and a buffer memory, the memory module comprising a plurality of chips, and each chip having a plurality of physical blocks grouped into a plurality of planes, wherein the memory controller comprises:
a memory interface control circuit, configured to be electrically connected to the memory module; and
a processor, electrically connected to the memory interface control circuit, wherein the processor is further electrically connected to a connection interface circuit of the storage device, so as to be electrically connected to a host system,
wherein the processor is configured to:
in response to one or more Force Unit Access (FUA) write commands, assign a unique command identifier to each Force Unit Access (FUA) write command;
record information on a plurality of phases experienced by a write operation corresponding to each command identifier;
consolidate and cache write data corresponding to one or more command identifiers into cache units corresponding to the plurality of planes in the buffer memory;
when the cache unit is full, write the cached write data of the cache units to the memory module through a multi-plane write mechanism; and
after all target write data corresponding to a target command identifier are successfully written to the memory module, transmit a success response to a host system, so as to indicate that the target Force Unit Access (FUA) write command corresponding to the target command identifier has been completed.

12. The memory controller as claimed in claim 11, wherein the plurality of phases comprise a trigger phase, a cache phase, and a completion phase, wherein:
after receiving the target Force Unit Access (FUA) write command corresponding to the target command identifier, a target write operation of the target command identifier enters the trigger phase;
after the target write data corresponding to the target command identifier is consolidated and cached into a target cache unit corresponding to the plurality of planes, the target write operation enters the cache phase;
after all the target write data corresponding to the target command identifier is successfully written from the target cache unit to the memory module through the multi-plane write mechanism, the target write operation enters the completion phase.

13. The memory controller as claimed in claim 12, wherein recording the information on the plurality of phases experienced by the write operation corresponding to each command identifier comprises:
establishing a status information table to record general status information of each command identifier;
maintaining a trigger linked list to record the command identifier corresponding to each received Force Unit Access (FUA) write command;
maintaining a wait linked list to record one or more command identifiers corresponding to each cache unit; and
maintaining a completion linked list to record command identifiers corresponding to completed Force Unit Access (FUA) write commands.

14. The memory controller as claimed in claim 13, wherein consolidating and caching the write data corresponding to the one or more command identifiers into the cache units corresponding to the plurality of planes in the buffer memory comprises:
extracting one or more first command identifiers from the trigger linked list to consolidate and cache corresponding first write data into a first cache unit, wherein a size of the first write data equals a size of the first cache unit, and the size of the cache unit corresponds to one Flash Super Page of the memory module;
removing the one or more first command identifiers from the trigger linked list; and
updating the one or more first command identifiers to the wait linked list and the status information table.

15. The memory controller as claimed in claim 13, wherein the status information table comprises structure elements in a quantity corresponding to a maximum number of command identifiers, each structure element having a one-to-one correspondence with one of the command identifiers, and each structure element comprising:
a next pointer field, configured to point to a next command identifier following the corresponding command identifier;
a cache unit count field, configured to record a total number of cache units storing write data corresponding to the command identifier;
a completion flag field, configured to indicate whether all write data corresponding to the command identifier has been cached; and
an error flag field, configured to indicate whether an error occurs during writing of the write data corresponding to the command identifier.

16. The memory controller as claimed in claim 13, wherein the trigger linked list comprises:
a first head pointer field, configured to point to a first command identifier in the trigger linked list;
a first tail pointer field, configured to point to a last command identifier in the trigger linked list; and
a first count field, configured to record a total number of command identifiers included in the trigger linked list.

17. The memory controller as claimed in claim 16, wherein after receiving the target Force Unit Access (FUA) write command, the processor is further configured to:
if the trigger linked list is empty, update the target command identifier to the first head pointer field and the first tail pointer field of the trigger linked list, and set the first count field of the trigger linked list to one;
if the trigger linked list is not empty, update the next pointer field of the structure element, in the status information table, corresponding to the command identifier pointed to by the current first tail pointer field to the target command identifier, update the target command identifier to the first tail pointer field of the trigger linked list, and increment the value of the first count field of the trigger linked list by one.

18. The memory controller as claimed in claim 13, wherein a total number of wait linked list elements of the wait linked list is configured according to a number of chips in the memory module, and each wait linked list element corresponds to one of the cache units, wherein each wait linked list element comprises:
a second head pointer field, configured to point to a first command identifier associated with the corresponding cache unit;
a second tail pointer field, configured to point to a last command identifier associated with the corresponding cache unit; and
a second count field, configured to record a total number of all command identifiers associated with the corresponding cache unit,
wherein when target write data corresponding to the target command identifier is cached to the target cache unit, the processor is configured to update the target command identifier to a target wait linked list element associated with the target cache unit, and increment a value of the cache unit count field of the corresponding structure element in the status information table by one.

19. The memory controller as claimed in claim 13, wherein after the cached write data of the target cache unit is successfully written to the memory module, the processor is further configured to:
decrement, by one, the value of the cache unit count field of the structure element of the status information table associated with each command identifier in the target wait linked list corresponding to the target cache unit; and
clear the target wait linked list.

20. The memory controller as claimed in claim 13, wherein the completion linked list comprises:
a third head pointer field, configured to point to a first command identifier in the completion linked list;
a third tail pointer field, configured to point to a last command identifier in the completion linked list; and
a third count field, configured to record a total number of command identifiers included in the completion linked list,
wherein when a value of the cache unit count field of a target structure element corresponding to the target command identifier in the status information table is decremented to zero and the completion flag field of the target structure element is a first value, the processor is configured to update the target command identifier to the completion linked list,
wherein after a success response corresponding to the target command identifier is transmitted to the host system, the processor is configured to remove the target command identifier from the completion linked list, and update the third head pointer field of the completion linked list to a next command identifier of the target command identifier.
